(19) United States
(12) Patent Application Publication
(10) Pub. No.: US 2017/0206663 A1
(43) Pub. Date: Jul. 20, 2017

(54) AIRSPACE INFORMATION PROCESSING DEVICE, AIRSPACE INFORMATION PROCESSING METHOD, AND NON-TRANSITORY COMPUTER-READABLE MEDIUM STORING AIRSPACE INFORMATION PROCESSING PROGRAM

(71) Applicant: NEC Corporation, Minato-ku, Tokyo (JP)

(72) Inventor: Masahiko ISHIDA, Tokyo (JP)

(73) Assignee: NEC Corporation, Minato-ku, Tokyo (JP)

(21) Appl. No.: 15/326,695

(22) PCT Filed: Jul. 17, 2014
(86) PCT No.: PCT/JP2014/003783

§ 371 Date: Jan. 17, 2017

(51) Int. Cl. G06T 7/11; G08G 5/00; G01C 21/20

(52) U.S. Cl. CPC G06T 7/11; G01C 21/20; G08G 5/006

(57) ABSTRACT

A transfer unit generates a transferred image by transferring a whole or part of a determination target closed curve, which represents an outline of an airspace and is formed of one or more line segments on a spherical surface, from its original position to another position on the spherical surface in such a manner that the transferred image has no intersection point with the determination target closed curve. A line segment generation unit generates, from the line segments forming the determination target closed curve, a determination line segment an intersection point with the transferred image and having no intersection point with other line segments forming the determination target closed curve. An airspace recognition unit recognizes, as the airspace, a region in which the determination line segment is not present, the region being one of two regions on the spherical surface that are defined by the determination target closed curve.

### TECHNICAL FIELD

The present invention relates to an airspace information processing device, an airspace information processing method, and a non-transitory computer-readable medium storing an airspace information processing program.

### BACKGROUND ART

Today, various navigation systems have been put into practice to monitor vehicles on the Earth. In order to manage the operation of aircraft whose travel distance is longer than that of other carriers, it is necessary to calculate the azimuth and distance of the aircraft in a wide area. Aircraft navigation systems are generally required to process large-scale spatial information accurately and effectively in a wide area such as a country's territory and airspace, or a flight information region (FIR).

For example, each air route of aircraft or the like can be represented by a line segment connecting two points on a true sphere. In this case, in order to ensure the security of the aircraft or the like, it is extremely important to determine whether or not two air routes intersect with each other. Further, each aircraft flies in an airspace set in the air in which the operation of the aircraft is allowed, thereby ensuring the security of the aircraft. In this case, if adjacent airspaces overlap one another, several aircrafts may enter into the overlapping airspace, which poses a problem in terms of security. Accordingly, it is necessary for the navigation systems mentioned above to appropriately design the airspace for ensuring the security of the aircraft.

As an example of such navigation systems, a method for determining a positional relationship to determine whether an arbitrary point is inside or outside a polygon on the Earth has been proposed. In this example, a search direction of each side of a polygon (in other words, a circumferential direction of a closed curve) for defining an airspace is taken into consideration to determine which one of right and left regions with respect to the circumference direction is an airspace.

Japanese Patent Application No. 2013-271712 proposes a technique for detecting, for various airspaces, an intersection point between line segments forming each airspace, and determining whether a vehicle is on the inside or outside of the airspace.

### CITATION LIST

### Patent Literature

[Patent Literature 1] Japanese Unexamined Patent Application Publication No. 2012-88902

### SUMMARY OF INVENTION

### Technical Problem

However, the present inventor has found that the above-mentioned techniques have the following problems. That is, depending on flight rules or airspace design specifications, it may be required to manage a large airspace extending across countries or continents. In this case, for example, it can be assumed that the circumferential direction of a closed curve for defining an airspace differs from country to country, or differs from airspace to airspace. To deal with this, the technique disclosed in Patent Literature 1 takes into consideration the circumferential direction of a closed curve (the probing direction of each side of a polygon), but does not take into consideration how to deal with a case where the direction of a closed curve for defining an airspace to be managed varies. If a plurality of airspaces including airspaces defined by closed curves with different circumferential directions are managed by the technique disclosed in Patent Literature 1, an unacceptable error in airspace design, such as false recognition as to the inside or outside region of an airspace due to a difference in the circumferential direction, may occur.

The present invention has been made in view of the above-mentioned circumstances, and an object of the present invention is to manage, in a unified manner, a plurality of airspaces each having an unspecified circumferential direction.

Another object of the present invention made in view of the above-mentioned circumstances is to correctly and accurately determine positional relationships in regions having arbitrary shapes and sizes on the ground.

### Solution to Problem

An airspace information processing device according to an aspect of the present invention includes: transfer means for generating a transferred image by transferring a whole or part of a closed curve representing an outline of an airspace from its original position to another position on a spherical surface in such a manner that the transferred image has no intersection point with the closed curve, the closed curve being formed of one or more line segments on the spherical surface; line segment generation means for generating, from the one or more line segments forming the closed curve, a determination line segment having an intersection point with the transferred image and having no intersection point with other line segments forming the closed curve; and airspace recognition means for recognizing, as the airspace, a region in which the line segment is present, the region being one of two regions on the spherical surface that are defined by the closed curve.

An airspace information processing method according to another aspect of the present invention includes: causing transfer means to generate a transferred image by transferring a whole or part of a closed curve representing an outline of an airspace from its original position to another position on a spherical surface in such a manner that the transferred image has no intersection point with the closed curve, the closed curve being formed of one or more line segments on the spherical surface; causing line segment generation means to generate, from the one or more line segments forming the closed curve, a determination line segment having an intersection point with the transferred image and having no intersection point with other line segments forming the closed curve; and causing airspace recognition means to recognize, as the airspace, a region in which the line segment is present, the region being one of two regions on the spherical surface that are defined by the closed curve.

A non-transitory computer-readable medium storing an airspace information processing program according to still another aspect of the present invention causes a computer to execute: processing for generating a transferred image by transferring a whole or part of a closed curve representing an outline of an airspace from its original position to another position on a spherical surface in such a manner that the transferred image has no intersection point with the closed curve, the closed curve being formed of one or more line segments on the spherical surface; processing for causing line segment generation means to generate, from the one or more line segments forming the closed curve, a determination line segment having an intersection point with the transferred image and having no intersection point with other line segments forming the closed curve; and processing for causing airspace recognition means to recognize, as the airspace, a region in which the line segment is present, the region being one of two regions on the spherical surface that are defined by the closed curve.

### Advantageous Effects of Invention

According to the present invention, a plurality of airspaces each having an unspecified circumferential direction can be managed in a unified manner.

### BRIEF DESCRIPTION OF DRAWINGS

FIG. 1 is a diagram showing a line segment connecting two points on a true sphere;

FIG. 2 is a diagram showing a circle on the true sphere;

FIG. 3 is a diagram showing an arc on the true sphere when the direction from a start point to an end point of the arc is counterclockwise;

FIG. 4 is a diagram showing an arc on the true sphere when the direction from a start point to an end point of the arc is clockwise;

FIG. 5 is a diagram showing an example of an airspace provided on the true sphere;

FIG. 6 is a diagram schematically showing a basic configuration of an airspace information processing device according to a first exemplary embodiment;

FIG. 7 is a diagram showing a configuration example of the airspace information processing device according to the first exemplary embodiment in which configurations of peripheral devices are added;

FIG. 8 is a flowchart showing an airspace information processing operation of the airspace information processing device according to the first exemplary embodiment;

FIG. 9 is a diagram showing a relationship between a determination target closed curve and a transferred image;

FIG. 10 is a flowchart showing line segment generation processing in the airspace information processing device according to the first exemplary embodiment;

FIG. 11 is a diagram showing line segment generation in a crescent-shaped airspace sandwiched between two arcs;

FIG. 12 is a diagram showing line segment generation in a crescent-shaped airspace sandwiched between two arcs;

FIG. 13 is a diagram showing line segment generation in a crescent-shaped airspace sandwiched between two arcs;

FIG. 14 is a diagram showing line segment generation in a circular airspace;

FIG. 15 is a diagram showing line segment generation in a circular airspace;

FIG. 16 is a diagram showing line segment generation in a rectangular airspace surrounded by four line segments;

FIG. 17 is a diagram showing line segment generation in a rectangular airspace surrounded by four line segments;

FIG. 18 is a flowchart showing processing of a triaxial rotation method;

FIG. 19 is a block diagram schematically showing a configuration of an intersection point detection unit according to a third exemplary embodiment;

FIG. 20 is a diagram showing information included in a basic form database;

FIG. 21 is a diagram showing information included in an airspace information database;

FIG. 22 is a block diagram schematically showing a basic configuration of an operation unit;

FIG. 23 is a flowchart showing an intersection point detection operation of the intersection point detection unit;

FIG. 24 is a diagram showing a case where the direction from a start point to an end point on the true sphere is eastward;

FIG. 25 is a diagram showing a case where the direction from a start point to an end point on the true sphere is westward;

FIG. 26 is a diagram showing line segments on the true sphere;

FIG. 27 is a diagram showing two line segments on the true sphere;

FIG. 28 is a diagram showing a case where two reference circles include two intersection points (intersecting with each other);

FIG. 29 is a diagram showing a case where two reference circles have a separation relationship;

FIG. 30 is a diagram showing a case where two reference circles have an inclusion relationship;

FIG. 31 is a diagram showing a case where two reference circles have a circumscribing relationship;

FIG. 32 is a diagram showing a case where two reference circles have an inscribing relationship;

FIG. 33 is a diagram showing a case where two reference circles match;

FIG. 34 is a diagram showing a case where reference circles match and two line segments are separated from each other;

FIG. 35 is a diagram showing a case where reference circles match and a start point of one of line segments overlaps an end point of the other one of the line segments;

FIG. 36 is a diagram showing a case where reference circles match and there is one overlapping portion between two line segments;

FIG. 37 is a diagram showing a case where reference circles match; a start point of one of line segments overlaps an end point of the other one of the line segments; and there is one overlapping portion between two line segments;

FIG. 38 is a diagram showing a case where reference circles match and there are two overlapping portions between two line segments;

FIG. 39 is a diagram showing line segments when a center angle Ψ is 2π (Ψ=2π);

FIG. 40 is a diagram showing line segments when the center angle Ψ is equal to or greater than π and smaller than 2π (π≦Ψ<2π);

FIG. 41 is a diagram showing line segments when the center angle Ψ is smaller than π (0<Ψ<π);

FIG. 42 is a flowchart showing an operation of detecting an intersection point between line segments in the intersection point detection unit;

FIG. 43 is a flowchart showing intersection point determination processing; and

FIG. 44 is a flowchart showing range verification processing.

### DESCRIPTION OF EMBODIMENTS

### First Exemplary Embodiment

An airspace information processing device 100 according to a first exemplary embodiment will be described. The airspace information processing device 100 is a device that manages, in a unified manner, pieces of information on a plurality of airspaces which are each defined by a closed curve formed of one or more line segments and have an unspecified circumferential direction. The airspace information processing device 100 is configured using hardware resources such as a computer system.

First, line segments forming a closed curve will be described as premises for understanding an airspace. Line segments on a true sphere can be roughly divided into the following three types.

A line segment connecting two points on the true sphere in the shortest distance

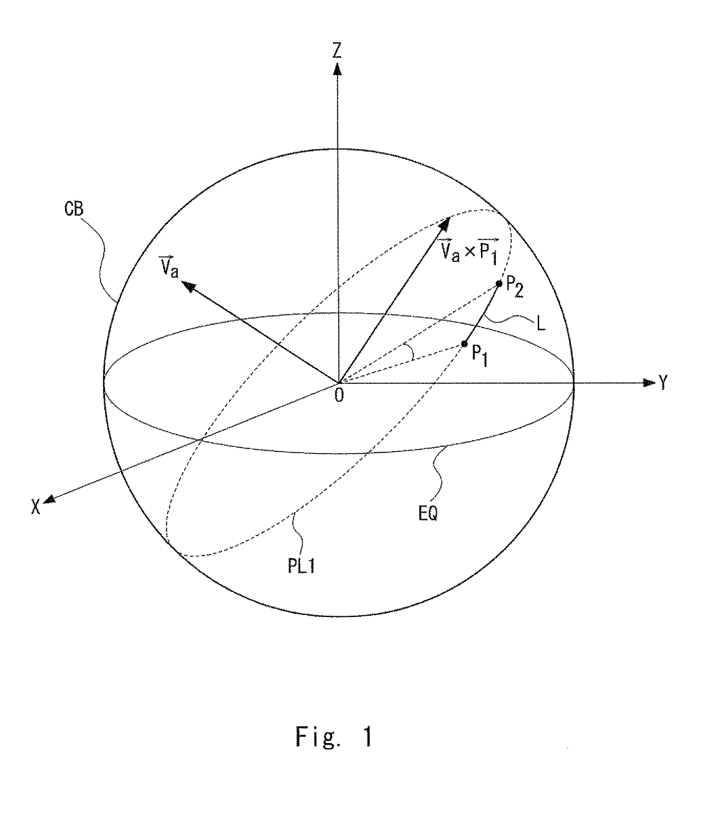

A line segment connecting a point P₁ and a point P₂ to each other on a true sphere CB (on the ground) will be described. FIG. 1 is a diagram showing a line segment L connecting the point P₁ and the point P₂ to each other on the true sphere CB. Vₐ represents a unit normal vector with respect to a plane PL1 to which the line segment L connecting the point P₁ and the point P₂ to each other belongs. The plane PL1 is a plane including the center of the true sphere CB. EQ represents the equator of the true sphere CB. The unit normal vector Vₐ with respect to the plane PL1 is represented by the following formula (1).

$$\begin{matrix}[ Formula 1 ] & \\ \vec{{V}_{a}} = \frac{( \vec{{P}_{1}} \times \vec{{P}_{2}} )}{\vert \vec{{P}_{1}} \times \vec{{P}_{2}} \vert} & ( 1 )\end{matrix}$$

Assuming that P represents a point on the line segment L connecting the point P₁ and the point P₂ to each other on the true sphere CB and sₐ represents the cosine of the angle formed between the unit normal vector Vₐ and the position vector of the point P, sₐ is represented by the following formula (2).

[Formula 2]

(\vec{Vₐ}·\vec{P})=sₐ (2)

Since it is apparent that the unit normal vector Vₐ and the line segment L are orthogonal to each other, the cosine Sₐ is 0. Accordingly, the point P on the line segment L can be defined as a point that satisfies the following formula (3).

[Formula 3]

(\vec{Vₐ}·\vec{P})=0 (3)

### A Circle on the True Sphere

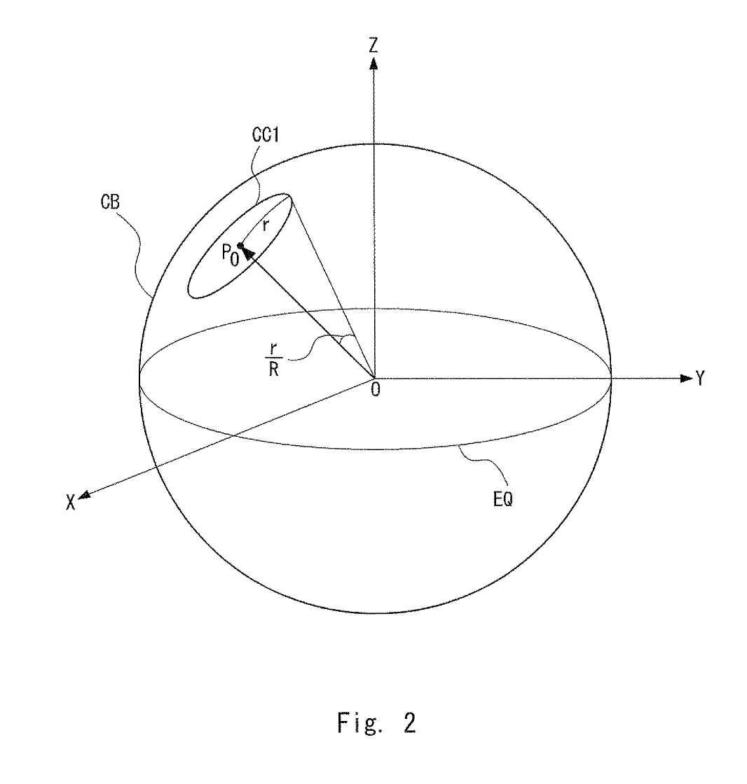

A circle on the true sphere CB will be described. FIG. 2 is a diagram showing a circle CC1 on the true sphere CB. The circle CC1 on the true sphere CB can be understood as being a set of points at a distance r from a certain point P₀. The position vector of the point P on the circumference of the circle CC1 satisfies each vector equation in the following formula (4) using the position vector of the point P₀. R represents the radius of the true sphere CB. V_{d} represents a unit normal vector of a plane to which the circle CC1 belongs and coincides with the position vector of the point P₀.

[Formula 4]

\vec{V_{d}}=\vec{P₀}

(\vec{V_{d}}·\vec{P})=s_{d} (4)

where s_{d} represents the cosine of the angle formed between the point P₀ and the point P on the true sphere CB, and is expressed by the following formula (5).

$$\begin{matrix}[ Formula 5 ] & \\ {s}_{d} = cos ( \frac{r}{R} ) & ( 5 )\end{matrix}$$

### An Arc Connecting Two Points on the True Sphere

An arc on the true sphere CB will be described. The arc on the true sphere CB can be understood as being a set of points at the distance r from the point P₀ on the true sphere CB.

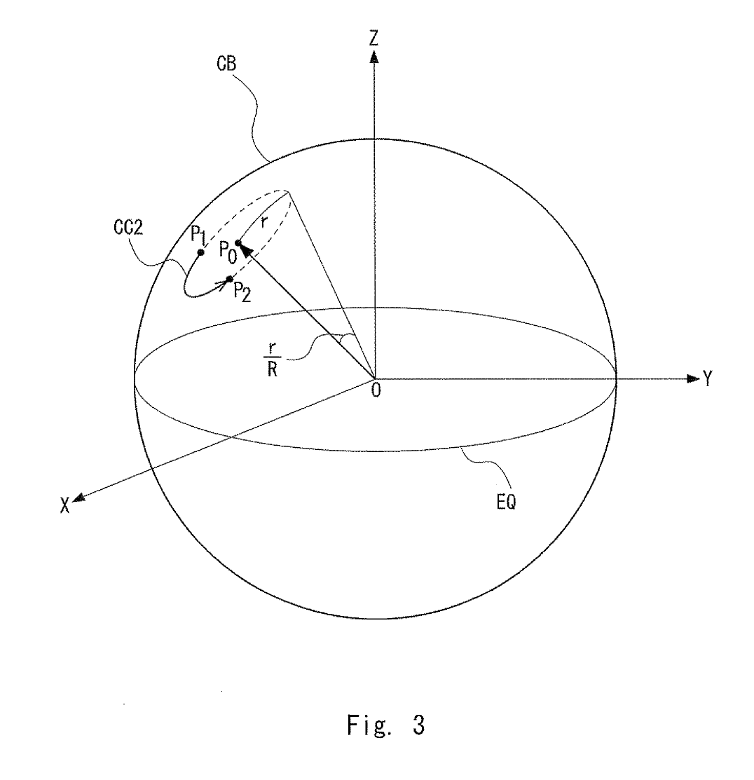

A case where the direction from a start point to an end point of the arc is counterclockwise will be described. FIG. 3 is a diagram showing an arc CC2 on the true sphere CB when the direction from the start point to the end point of the arc is counterclockwise. When the direction between the two points is counterclockwise, the position vector of the point P on the arc CC2 satisfies each vector equation in the following formula (6). R represents the radius of the true sphere CB. Vₑ represents a unit normal vector of a plane to which the arc CC2 belongs and coincides with the position vector of the point P₀.

[Formula 6]

\vec{Vₑ}=\vec{P₀}

(\vec{Vₑ}·\vec{P})=sₑ (6)

where s_{d} represents the cosine of the angle formed between the point P₀ and the point P on the true sphere, and is expressed by the following formula (7).

$$\begin{matrix}[ Formula 7 ] & \\ {s}_{e} = cos ( \frac{r}{R} ) & ( 7 )\end{matrix}$$

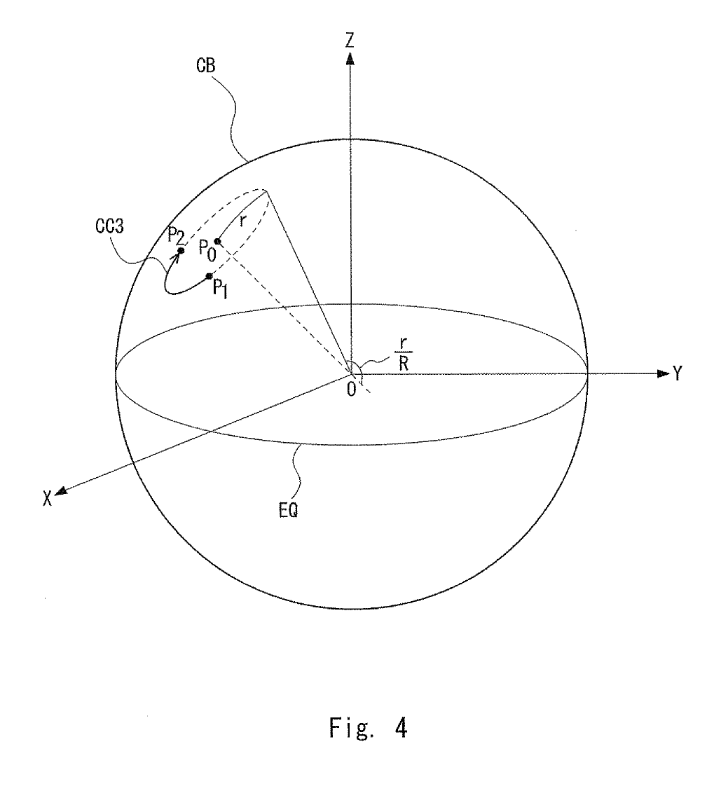

A case where the direction from a start point to an end point of an arc is clockwise will be described. FIG. 4 is a diagram showing an arc CC3 on the true sphere CB when the direction from the start point to the end point of the arc is clockwise. When the direction between the two points is clockwise, the position vector of the point P on the arc CC3 satisfies each vector equation in the following formula (8). R represents the radius of the true sphere CB. Vₑ represents a unit normal vector of a plane to which the arc CC3 belongs, and the direction of the unit normal vector is opposite to the direction of the position vector of the point P₀.

[Formula 8]

\vec{Vₑ}=−\vec{P₀}

(\vec{Vₑ}·\vec{P})=sₑ (8)

sₑ is equal to the cosine of the angle formed between the point P₀ on the true sphere CB and an arbitrary point P on the arc, and has a negative sign. sₑ is represented by the following formula (9).

$$\begin{matrix}[ Formula 9 ] & \\ {s}_{e} = - cos ( \frac{r}{R} ) & ( 9 )\end{matrix}$$

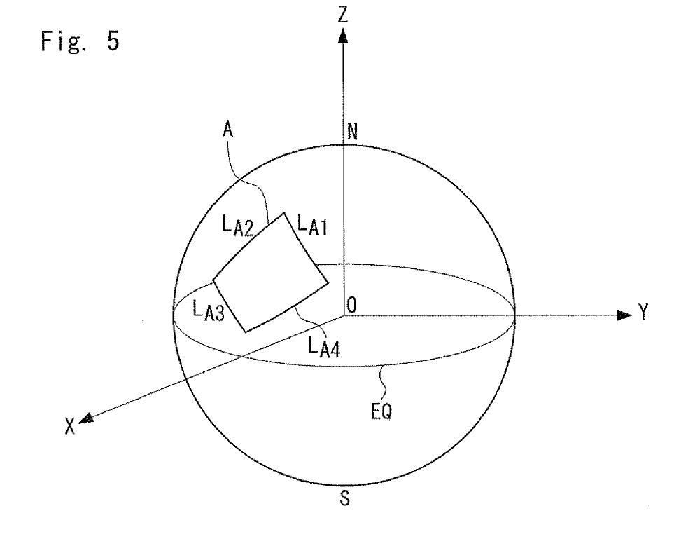

Next, an airspace set on the true sphere will be described. FIG. 5 is a diagram showing an example of the airspace provided on the true sphere CB. In FIG. 5, an airspace A is surrounded by a closed curve formed of line segments L_{A1} to L_{A4}, thereby separating the airspace A from an external region. The airspace shown in FIG. 5 is illustrated by way of example only. The number of line segments surrounding the airspace A may be one (i.e., a circle on the true sphere CB) or any plural number other than four. In the example shown in FIG. 5, when a vehicle travels counterclockwise while viewing the closed curve formed of the line segments L_{A1} to L_{A4} from the outside of the true sphere, the region that can be seen on the left side as viewed from the line segments on the true sphere is defined as the airspace A. Accordingly, in this case, the region on the true sphere that can be seen on the right side as viewed from the line segments is defined as a region outside of the airspace A.

In summary, it can be understood that, when an airspace is defined, the following two pieces of information are required.

### (1) Line Segment Information

Specification of one or more line segments surrounding the airspace.

### (2) Direction Information

Specification of a direction (counterclockwise or clockwise) when the closed curve formed of the one or more line segments surrounding the airspace is viewed from the outside of the true sphere.

However, it is assumed that the airspace information processing device 100 according to this exemplary embodiment manages a considerably large airspace on the true sphere. Accordingly, it is necessary to collectively manage pieces of airspace information created by different subjects, such as an organization, a corporation, a country, and the like.

In this case, a start point and an end point (for example, the points P₁ and P₂ shown in FIG. 1) of each line segment can be provided as line segment information to specify each of the line segments surrounding the airspace. Further, when a path connecting the start point and the end point is not uniquely defined, information for specifying a path for each line segment as shown in the above formula (3) can be added to the line segment information. In other words, the line segment information can be mathematically, uniquely defined. Therefore, even when the airspace definition rules vary among the organizations, corporations, countries, and the like that manage the airspace, it is sufficient to represent each line segment surrounding the airspace in any fashion. Thus, the varying of the line segment information poses no problem.

On the other hand, it is necessary to carefully manage the direction information for the following reason. That is, as for the direction information, the direction of the closed curve is artificially determined. Therefore, the direction of the closed curve may vary among organizations, corporations, countries, and the like that manage the airspace. For example, it can be assumed that the direction of the closed curve is specified as counterclockwise in a country A, while the direction of the closed curve is specified as clockwise in a country B. In this case, the direction of the closed curve is defined as counterclockwise in a system using the airspace information of the country A. Accordingly, if the line segment information created in the country B is input to a system of the country A to recognize the airspace, the system of the country A recognizes that the airspace indicated by the line segment information of the country B is outside of the airspace. That is, in such a case, false recognition of the airspace occurs.

In order to avoid this, it is possible to specify the direction information for each piece of line segment information created by different subjects, such as an organization, a corporation, and a country. However, in existing systems, it is not assumed that a wide range of airspace is managed like in the airspace information processing device 100 according to this exemplary embodiment. Accordingly, the existing systems do not have any function for adding the direction information for specifying the direction of the closed curve to the line segment information for specifying the airspace. Even if the direction information is added, the amount of information to be input to the system increases, and if the direction information is erroneously specified, a problem similar to that described above arises.

The area of an airspace defined by a closed curve is generally smaller than half of the surface area of the Earth, as is obvious from the intended use thereof. Therefore, when the area of the airspace is compared with the area of the region outside of the airspace, the smaller area can be discriminated as being the airspace. However, a vast number of calculations are required to obtain the area of each region defined by a closed curve on the sphere, which is not suitable for processing for simply recognizing an airspace. Particularly when a plurality of airspaces are managed, a vast number of calculations are required merely for enabling the system to recognize an airspace, and thus it is not practical.

On the other hand, the airspace information processing device 100 according to this exemplary embodiment can recognize an airspace accurately with a small number of calculations based on the airspace information with various directions of closed curves. The airspace information processing device 100 will be described in detail below.

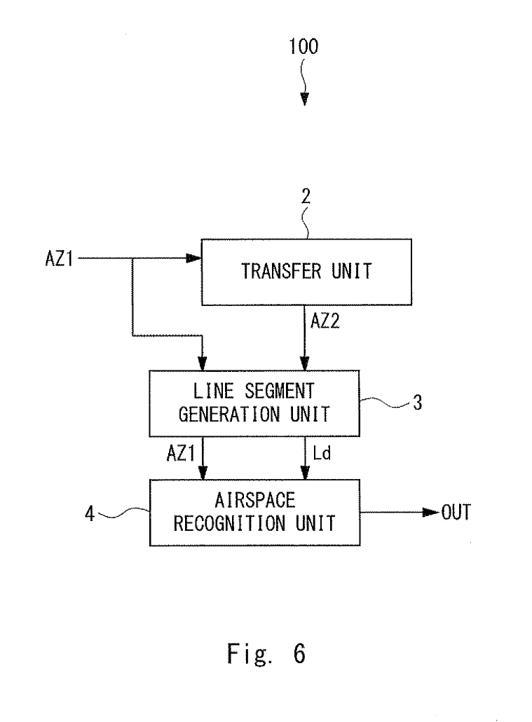

FIG. 6 is a diagram schematically showing the basic configuration of the airspace information processing device 100 according to the first exemplary embodiment. The airspace information processing device 100 includes a transfer unit 2, a line segment generation unit 3, and an airspace recognition unit 4.

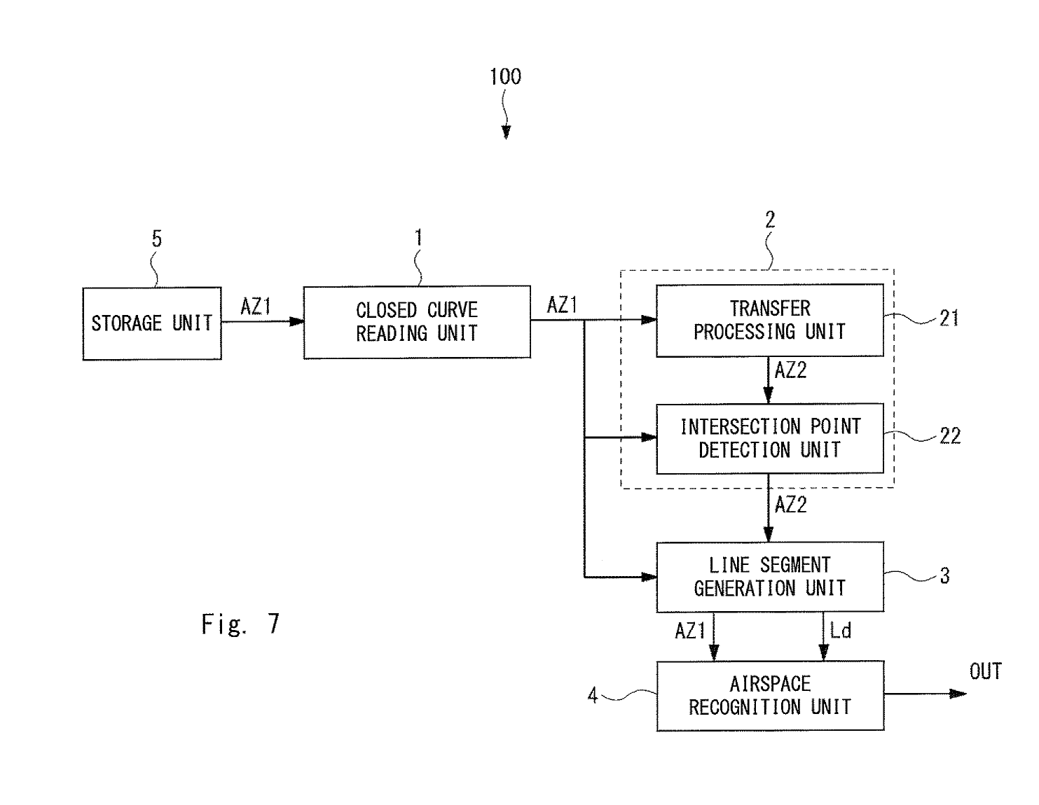

FIG. 7 is a diagram schematically showing a configuration example of the airspace information processing device 100 in which configurations of peripheral devices are added. In FIG. 7, a closed curve reading unit 1 and a storage unit 5 are provided in addition to the transfer unit 2, the line segment generation unit 3, and the airspace recognition unit 4 shown in FIG. 6. Note that in FIG. 2, the transfer unit 2 includes a transfer processing unit 21 and an intersection point detection unit 22.

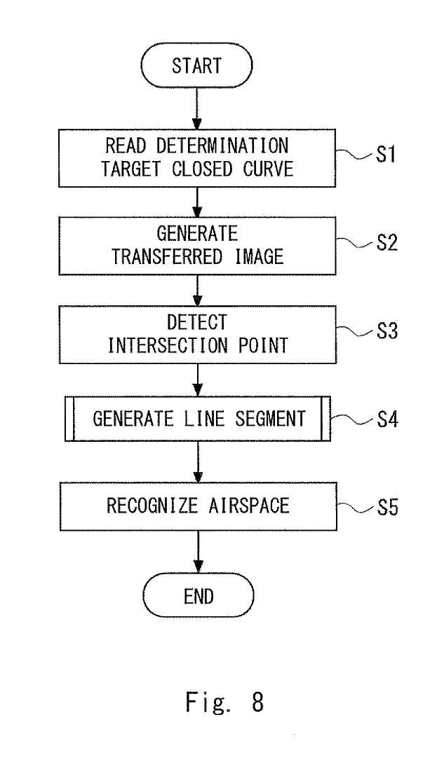

An operation of the airspace information processing device 100 according to this exemplary embodiment will be described. The airspace information processing device 100 performs an inside/outside determination on an airspace defined by the determination target closed curve, based on the relationship between the closed curve (the determination target closed curve and a transferred image) representing the outline of two airspaces spatially isolated from each other. FIG. 8 is a flowchart showing the airspace information processing operation of the airspace information processing device 100 according to the first exemplary embodiment.

### Step S1: Reading of a Determination Target Closed Curve AZ1

First, the closed curve reading unit 1 reads the determination target closed curve AZ1. At this time, a circumferential direction is not given to the determination target closed curve AZ1, and the determination target closed curve AZ1 represents only the outline of the airspace. Therefore, it is unclear which one of the two regions on the true sphere CB defined by the determination target closed curve AZ1 corresponds to the airspace. Specifically, in this case, the closed curve reading unit 1 reads line segment information specifying the determination target closed curve AZ1 which is preliminarily stored in the storage unit 5. In the example shown in FIG. 5, the closed curve reading unit 1 reads information indicating the line segments L_{A1} to L_{A4} which form the closed curve representing the airspace A. The closed curve reading unit 1 can output the read information indicating the determination target closed curve AZ1 to each of the transfer unit 2 and the line segment generation unit 3.

### Step S2: Generation of a Transferred Image (Inverted Transferred Image) AZ2

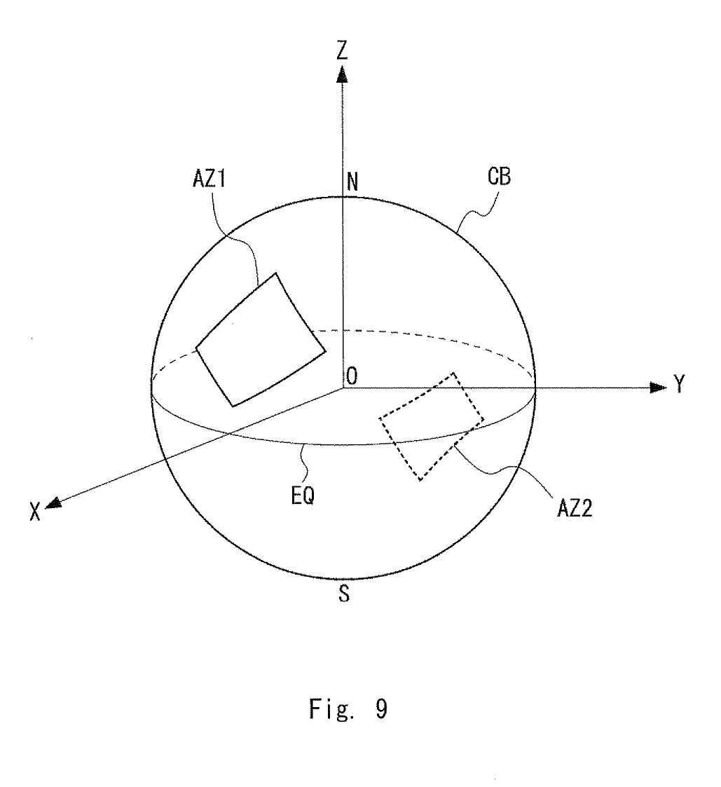

The transfer processing unit 21 of the transfer unit 2 generates the transferred image AZ2 by transferring the closed curve reading unit 1 from its original position to another position on the true sphere. In this exemplary embodiment, the transfer processing unit 21 generates, as the transferred image AZ2, an inverted transferred image by transferring the determination target closed curve AZ1 to a point-symmetrical position about the center of the true sphere CB. FIG. 9 is a diagram showing the relationship between the determination target closed curve AZ1 and the transferred image AZ2. In FIG. 9, the determination target closed curve AZ1 is present on the front side of the true sphere CB, and thus the transferred image AZ2 (indicated by a dashed line) is present on the back side of the true sphere about a center O of the true sphere CB.

### Step S3: Detection of an Intersection Point

As described above, the airspace information processing device 100 performs the inside/outside determination on the determination target closed curve AZ1 based on the positional relationship between two airspaces, which are spatially isolated from each other, and a line segment drawn between the two airspaces. Accordingly, it is necessary to secure the state in which the determination target closed curve AZ1 and the transferred image AZ2 are spatially isolated. Therefore, in this case, the transfer processing unit 21 of the transfer unit 2 determines whether or not the determination target closed curve AZ1 and the transferred image AZ2 have an intersection point. The intersection point described herein does not include a contact point between the determination target closed curve AZ1 and the transferred image AZ2. In other words, when the determination target closed curve AZ1 and the transferred image AZ2 have an intersection point, it is impossible to determine the circumferential direction, and thus the processing is cancelled.

### Step S4: Generation of a Line Segment

When the determination target closed curve AZ1 and the transferred image AZ2 are spatially isolated (when the determination target closed curve AZ1 and the transferred image AZ2 have no intersection point), the line segment generation unit 3 generates a line segment, which passes through the transferred image AZ2, from points on the line segment closest to the transferred image AZ2 among the line segments L_{A1} to L_{A4} of the determination target closed curve AZ1.

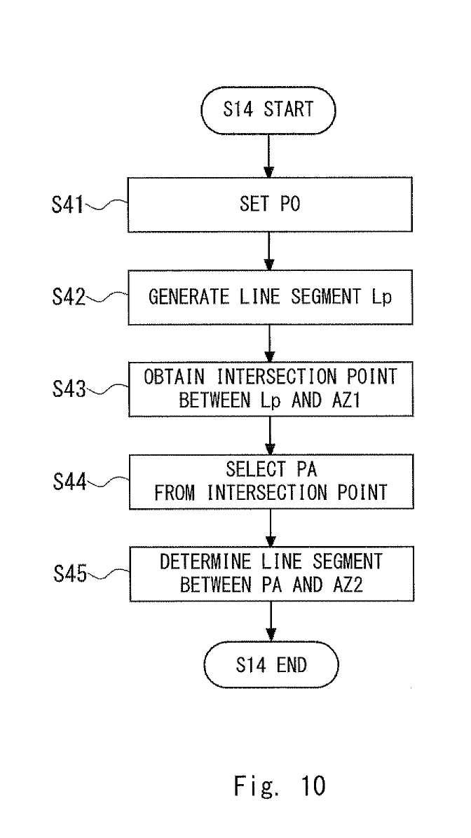

The generation of a line segment (step S14) will be described in more detail. FIG. 10 is a flowchart showing line segment generation processing in the airspace information processing device 100 according to the first exemplary embodiment.

### Step S41

An arbitrary point P₀ (also referred to as a first point) is set on an arbitrary line segment among the line segments forming an airspace.

### Step S42

A temporal line segment Lp (also referred to as a first line segment) having an intersection point with a line segment forming the transferred image AZ2 is subtracted from the point P₀.

### Step S43

Intersection points between the line segment Lp and the line segments of the determination target closed curve AZ1 other than the line segment on which the point P0 is set are obtained.

### Step S44

Among the intersection points obtained as described above, an intersection point closest to the transferred image AZ2 is selected as a point PA. Assume herein that the intersection point includes the point P₀ which is an endpoint of the line segment Lp.

### Step S45

In the temporal line segment Lp, an interval between the point PA and any point on the transferred image AZ2 is set as a determination line segment Ld. In this case, as any point on the transferred image AZ2, for example, a point (also referred to as a second point) that is closest to the determination target closed curve AZ1 among the intersection points between the temporal line segment Lp and the line segments forming the transferred image AZ is used. In this case, however, the definition of any point on the transferred image AZ2 is not limited to this.

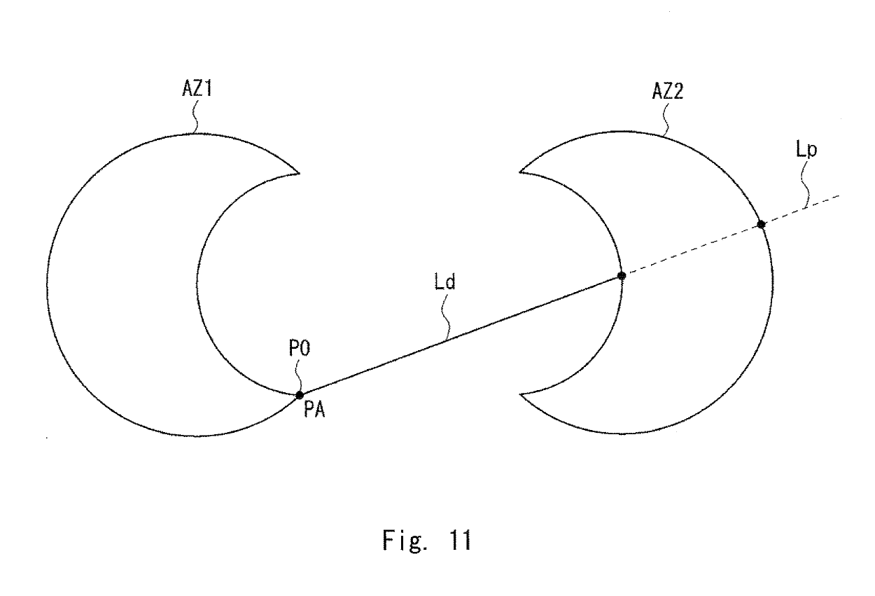

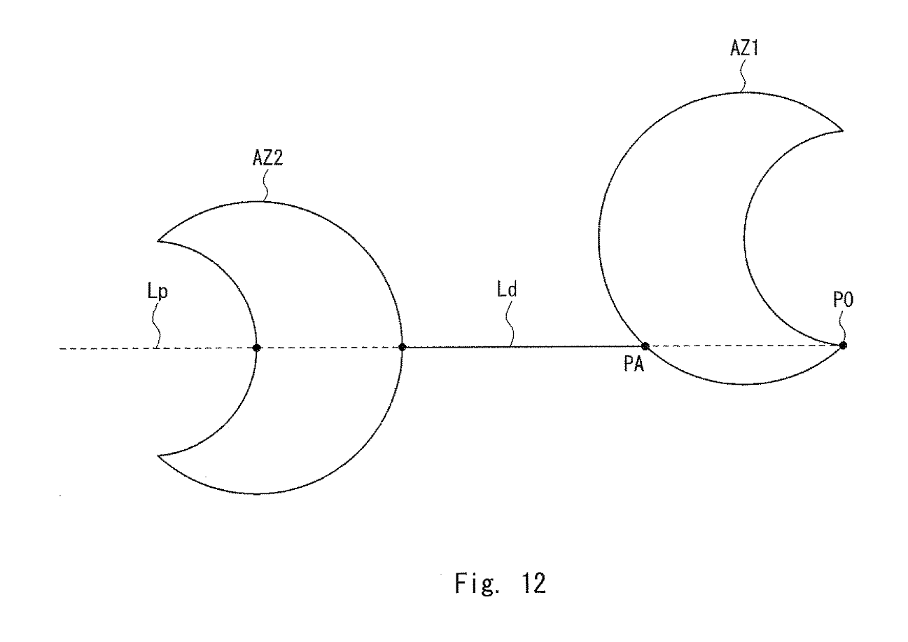

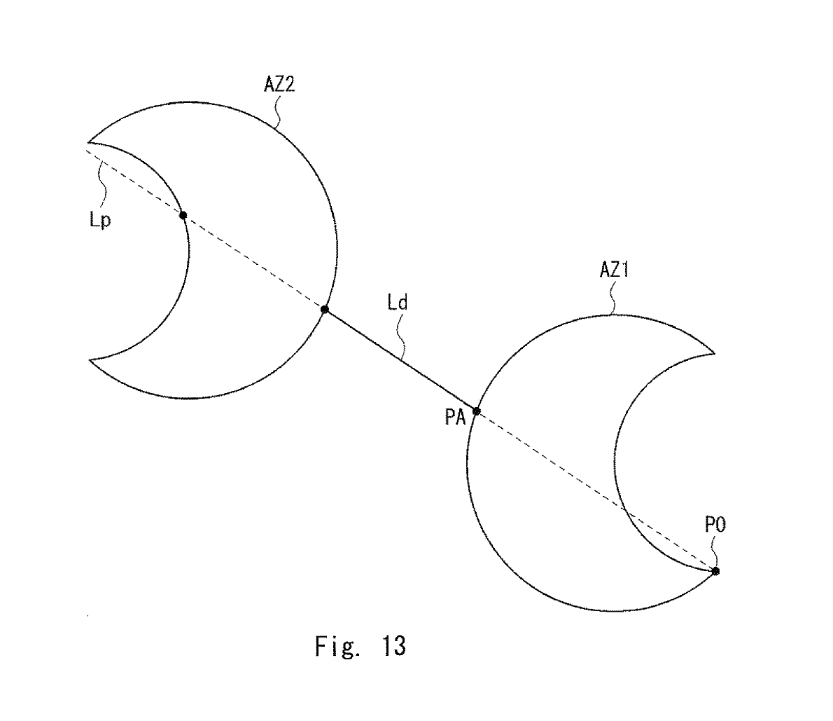

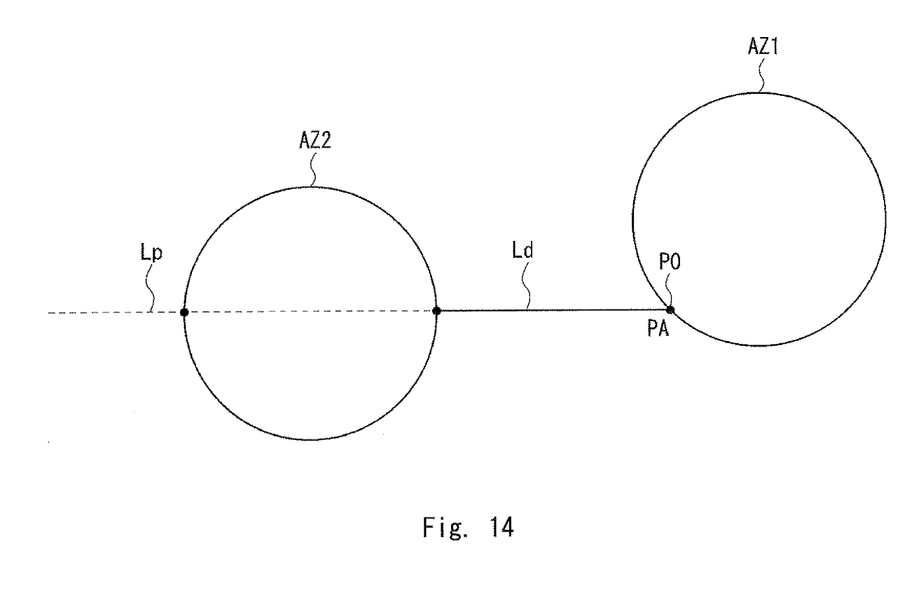

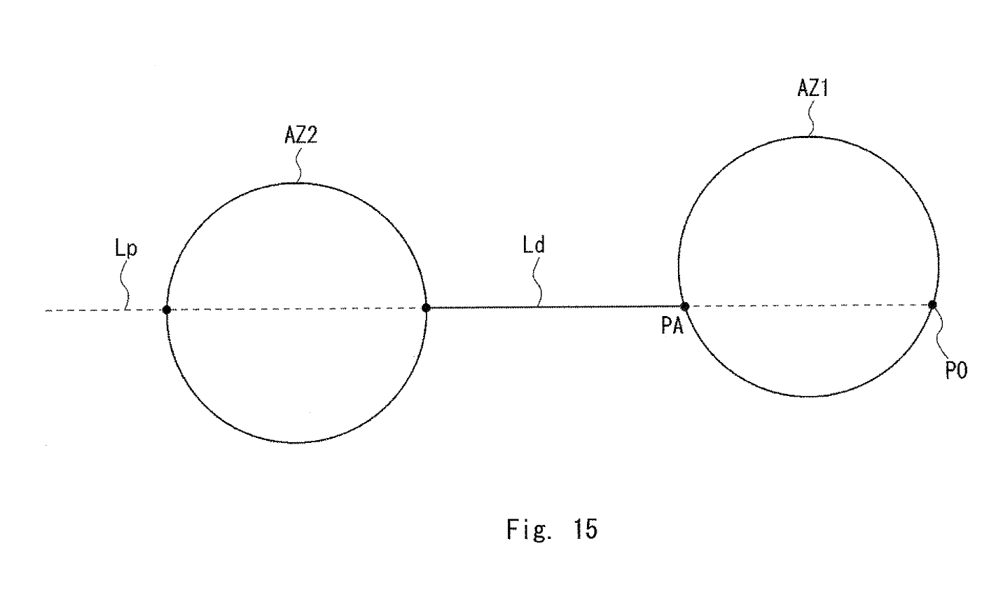

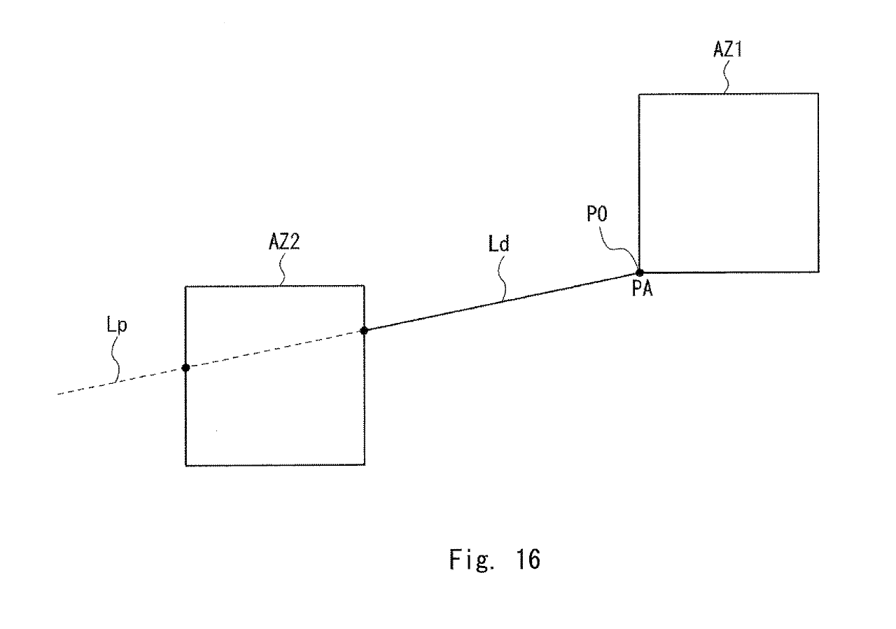

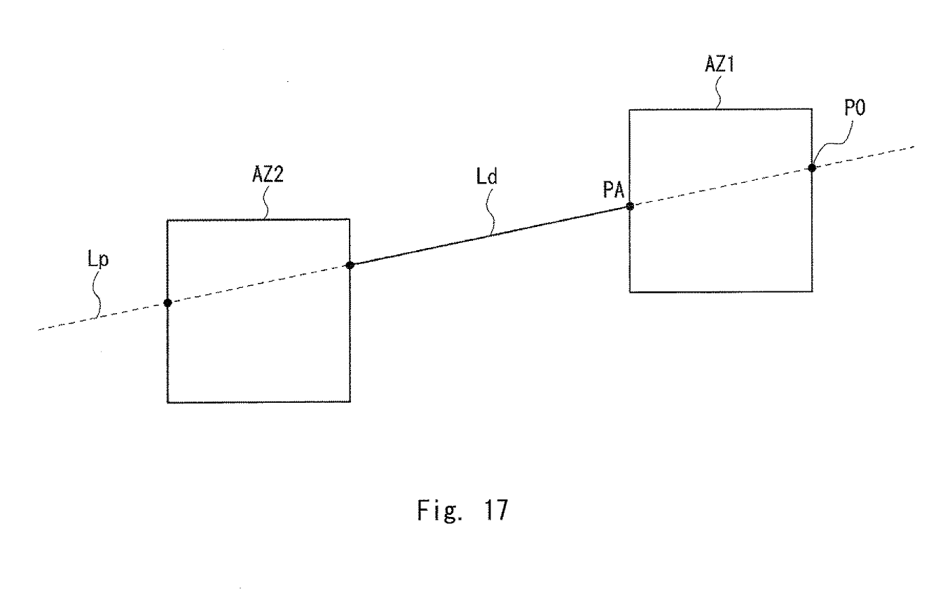

By the above-described steps S41 to S45, the generation of a line segment can be carried out in the above-described step S14. FIGS. 11 to 17 show an example of generating a line segment. For simplification of the drawing, an airspace is approximately represented on a plane in FIGS. 11 to 17. FIGS. 11 to 13 are diagrams each showing the generation of a line segment in a crescent-shaped airspace surrounded by two arcs. FIGS. 14 and 15 are diagrams each showing the generation of a line segment in a circular airspace. FIGS. 16 and 17 are diagrams showing the generation of a line segment in a rectangular airspace surrounded by four line segments.

### Step S15: Recognition of an Airspace

Referring again to FIG. 10, the airspace information processing operation of the airspace information processing device 100 will be further described below.

In two regions defined by the closed curve representing the airspace, the region located on the left side when the boundary between the regions is followed in the direction in which the airspace is defined is represented by A1, and the region located on the right side when the boundary between the regions is followed in the direction in which the airspace is defined is represented by A2. Since it is apparent that the transferred image AZ2 is located outside of the determination target closed curve AZ1, it is apparent that the determination line segment Ld is output outward from the line segment that defines the determination target closed curve AZ1.

In this case, when the determination line segment Ld is present on the right side as viewed from the line segment having an intersection point (that is, the point PA) with the determination line segment Ld, i.e., in the right-side region A2, it can be determined that the left-side region A1 represents the airspace.

Further, when the determination line segment Ld is present on the left side as viewed from the line segment having an intersection (that is, the point PA) with the determination line segment Ld, i.e., in the left-side region A1, it can be determined that the right-side region A2 represents the airspace.

As described above, in step S5, it can be recognized which one of the right and left closed curves represents the determination target closed curve AZ1 by determining in which one of the right and left regions of the closed curves (line segments forming the airspace), the determination line segment Ld is present.

After that, the circumferential direction of the recognized airspace may be set so as to be identical with the circumferential direction of the closed curve set by the airspace information processing device 100. For example, when the circumferential direction of the airspace is defined to be counterclockwise, the circumferential direction is a direction in which the determination line segment Ld is viewed on the right side. When the circumferential direction of the airspace is defined to be clockwise, the circumferential direction is a direction in which the determination line segment Ld is viewed on the left side.

Note that the above description is made assuming that the transferred image AZ2 is generated, but the entire airspace need not necessarily be transferred. Instead, only a part of the airspace on the closed curve forming the determination target closed curve AZ1 may be transferred. Further, a part of the airspace on the closed curve to be transferred is not necessarily a line segment, but instead may be a point. Furthermore, the line segment Lp passing through the transferred line segment or the transferred point may be generated. When the line segment Lp passes through the transferred point, the location where the transferred point is present on the line segment Lp is also referred to as an intersection point, for convenience of explanation. However, this is applicable only when it is apparent that the transferred point is not included in the determination target closed curve AZ1. In this case, the above-mentioned detection of an intersection point (step S12) may be omitted, which is advantageous as the number of calculations is reduced.

Instead of the transferred point, another point that is apparently not included in the determination target closed curve AZ1 may be used.

For example, practically, it is highly unlikely that an airspace including the south pole is set, and thus the south pole can be used as another point described above.

### Second Exemplary Embodiment

An airspace information processing device according to a second exemplary embodiment will be described. In this exemplary embodiment, modified examples for the method of generating the transferred image AZ2 will be described. In the first exemplary embodiment, the inverted transferred image of the determination target closed curve AZ1 is used as the transferred image AZ2. However, any image having no intersection point with the determination target closed curve AZ1 can be used as the transferred image AZ2, and thus the modified examples for the method of generating the transferred image AZ2 can be applied.

### MODIFIED EXAMPLE 1

### Airspace Centroid Method

A center-of-gravity point G of the determination target closed curve AZ1 is obtained and a vector OG connecting the center-of-gravity point G and the center O of the true sphere CB is obtained. Further, an image obtained by rotating and duplicating the determination target closed curve AZ1 by a predetermined angle (for example, 90°, 120°, or 180°) using, as a rotation axis, a vector perpendicular to the vector OG passing through the center O of the true sphere CB is set as the transferred image AZ2. In this case, the calculation of the center-of-gravity point G of the determination target closed curve AZ1 requires an appropriate number of calculations.

### MODIFIED EXAMPLE 2

### Vector Averaging Method

For example, a plurality of points (XYZ perpendicular coordinates) are set at regular intervals on a closed curve surrounding the determination target closed curve AZ1, and the average vector of the position vectors of the plurality of set points is obtained. Further, an image obtained by rotating and duplicating the determination target closed curve AZ1 by a predetermined angle (for example, 90°, 120°, or 180°) using a vector perpendicular to the average vector passing through the center O of the true sphere CB as a rotation axis is set as the transferred image AZ2. In this case, the calculation of the average vector is easier than the calculation of the center-of-gravity point G of the determination target closed curve AZ1, and thus the number of calculations can be reduced.

### MODIFIED EXAMPLE 3

### Latitude/Longitude Averaging Method

For example, a plurality of points are set at regular intervals on a closed curve surrounding the determination target closed curve AZ1. Average latitude and longitude coordinates composed of average values of the latitudes and longitudes of the plurality of set points are obtained and a vector connecting the average latitude and longitude coordinates and the center O of the true sphere CB is obtained. Further, an image obtained by rotating and duplicating the determination target closed curve AZ1 by a predetermined angle (for example, 90°, 120°, or 180°) using, as a rotation axis, a vector which is perpendicular to the obtained vector and passes through the center O of the true sphere CB is set as the transferred image AZ2. In this case, the calculation of the average latitude and longitude coordinates is easier than the calculation of the center-of-gravity point G of the determination target closed curve AZ1, and thus the number of calculations can be reduced.

### MODIFIED EXAMPLE 4

### Composition Point Extraction Method

A vector connecting the center O of the true sphere CB and an arbitrary point on a closed curve surrounding the determination target closed curve AZ1 is obtained. Further, an image obtained by rotating and duplicating the determination target closed curve AZ1 by a predetermined angle (for example, 90°, 120°, or 180°) using, as a rotation axis, a vector which is perpendicular to the obtained vector and passes through the center O of the true sphere CB is set as the transferred image AZ2. In this case, it is only necessary to obtain an arbitrary point on a closed curve surrounding the determination target closed curve AZ1, and thus the number of calculations can be reduced.

### MODIFIED EXAMPLE 5

### Composition Point Pair Extraction Method

Two points are set in such a manner that the distance between the two points on a closed curve surrounding the determination target closed curve AZ1 is maximum, and a middle point between the set two points is obtained. Further, a vector connecting the middle point and the center O of the true sphere CB is obtained. Furthermore, an image obtained by rotating and duplicating the determination target closed curve AZ1 by a predetermined angle (for example, 90°, 120°, or 180°) using, as a rotation axis, a vector which is perpendicular to the obtained vector and passes through the center O of the true sphere CB is set as the transferred image AZ2. In this case, it is only necessary to obtain a middle point, and thus the number of calculations can be reduced.

### MODIFIED EXAMPLE 6

### Triaxial Rotation Method

The rotation of coordinates at an arbitrary angle in a three-dimensional manner in the modified examples described above includes the calculations of three floating-point parameters and the trigonometric-function, so that a computing error is likely to occur. On the other hand, Modified Example 6 relates to a method of generating the transferred image AZ2 in which a computing error does not occur in principle.

The XYZ axes are set on the true sphere CB as shown in, for example, FIG. 5. In this case, when the true sphere CB is the Earth, the Z-axis corresponds to the axis of the Earth. Note that the X-axis is also referred to as a second rotation axis; the Y-axis is referred to as a third rotation axis; and the Z-axis is referred to as a first rotation axis.

The rotation about the first rotation axis (Z-axis) indicates that an X-Y plane (X-Y coordinates) rotates about the Z-axis. The rotation about the second rotation axis (X-axis) indicates that a Y-Z plane (Y-Z coordinates) rotates about the X-axis. The rotation about the third rotation axis (Y-axis) indicates that a Z-X plane (Z-X coordinates) rotates about the Y-axis.

The triaxial rotation method will be described in detail below. FIG. 18 is a flowchart showing processing of the triaxial rotation method. Step S10 to S19 illustrated in FIG. 18 correspond to steps S12 and S13 shown in FIG. 8.

### Step S10

First, the determination target closed curve AZ1 is rotated about the Z-axis by 180° to generate a transferred image. The image obtained in this case is represented as a transferred image AZ2_Z. In this case, coordinates (x, y, z) on the determination target closed curve AZ1 are transferred to coordinates (−x, −y, z). Although the term “triaxial rotation method” includes “rotation”, it can be understood that, in practice, it is only necessary to perform a simple operation for inverting the signs of x and y coordinates of coordinate information defining a closed curve surrounding the determination target closed curve AZ1.

### Step S11

It is detected whether the determination target closed curve AZ1 and the transferred image AZ2_Z have an intersection point. In this case, the intersection point detection process can be performed by a method similar to that in the above-mentioned step S12.

### Step S12

When the determination target closed curve AZ1 and the transferred image AZ2_Z have no intersection point, the transferred image AZ2_Z is set as the transferred image AZ2, and the processing is terminated.

### Step S13

When the determination target closed curve AZ1 and the transferred image AZ2_Z have an intersection point, the determination target closed curve AZ1 is rotated about the X-axis by 180° to generate a new transferred image. The image obtained in this case is represented as a transferred image AZ2_X. In this case, coordinates (x, y, z) on the determination target closed curve AZ1 are transferred to coordinates (x, −y, −z). Although the term “triaxial rotation method” includes “rotation”, it can be understood that, in practice, it is only necessary to perform a simple operation for inverting the signs of y and z coordinates of coordinate information defining a closed curve surrounding the determination target closed curve AZ1.

### Step S14

It is detected whether the determination target closed curve AZ1 and the transferred image AZ2_X have an intersection point. The intersection point detection process in this case may be performed by a method similar to the above-mentioned step S12.

### Step S15

When the determination target closed curve AZ1 and the transferred image AZ2_X have no intersection point, the transferred image AZ2_X is set as the transferred image AZ2, and the processing is terminated.

### Step S16

When the determination target closed curve AZ1 and the transferred image AZ2_X have an intersection point, the determination target closed curve AZ1 is rotated about the Y-axis by 180° to generate a new transferred image. The image obtained in this case is represented as a transferred image AZ2_Y. In this case, coordinates (x, y, z) on the determination target closed curve AZ1 are transferred to coordinates (−x, y, −z). Although the term “triaxial rotation method” includes “rotation”, it can be understood that, in practice, it is only necessary to perform a simple operation for inverting the signs of x and z coordinates of coordinate information defining a closed curve surrounding the determination target closed curve AZ1.

### Step S17

It is detected whether the determination target closed curve AZ1 and the transferred image AZ2_Y have an intersection point. The intersection point detection process in this case can be performed by a method similar to the above-mentioned step S12.

### Step S18

When the determination target closed curve AZ1 and the transferred image AZ2_Y have no intersection point, the transferred image AZ2_Y is set as the transferred image AZ2, and the processing is terminated.

### Step S19

When the determination target closed curve AZ1 and the transferred image AZ2_Y have an intersection point, the creation of the transferred image AZ2 is cancelled and the processing is terminated.

Although the term “triaxial rotation method” includes “rotation”, in practice, it is only necessary to perform a simple operation for inverting the sign of coordinate information defining a closed curve surrounding the determination target closed curve AZ1. Therefore, the number of calculations can be reduced as compared with those in Modified Examples 1 to 5 described above.

Since the inverted transferred image described in the first exemplary embodiment is generated by transferring the determination target closed curve AZ1 to a point-symmetrical position about the center of the true sphere CB, the circumferential direction of the determination target closed curve AZ1 is opposite to the circumferential direction of the inverted transferred image. On the other hand, in the triaxial rotation method, the transferred image AZ2 can be generated while maintaining the circumferential direction unchanged.

In addition, for example, in Modified Examples 1 to 5, the amount of rotation of a closed curve can be arbitrarily determined. A closed curve may be rotated a plurality of times until the determination target closed curve AZ1 and the transferred image AZ2 have no intersection point. When a closed curve is rotated a plurality of times, Modified Examples 1 to 5 may be combined as appropriate.

### Third Exemplary Embodiment

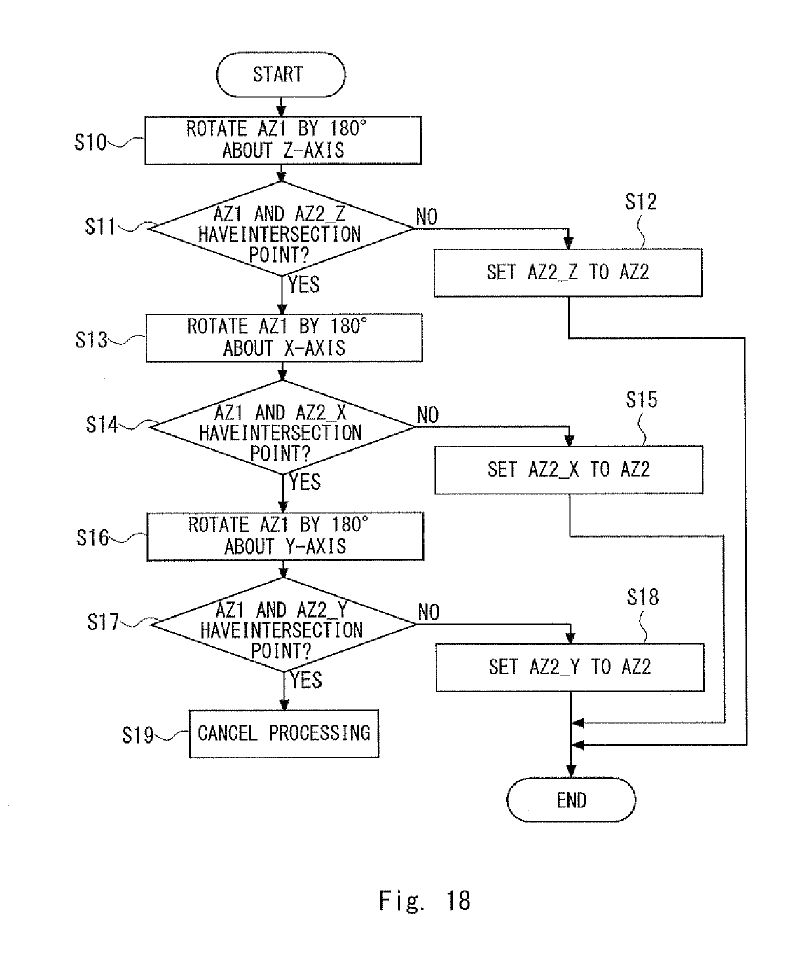

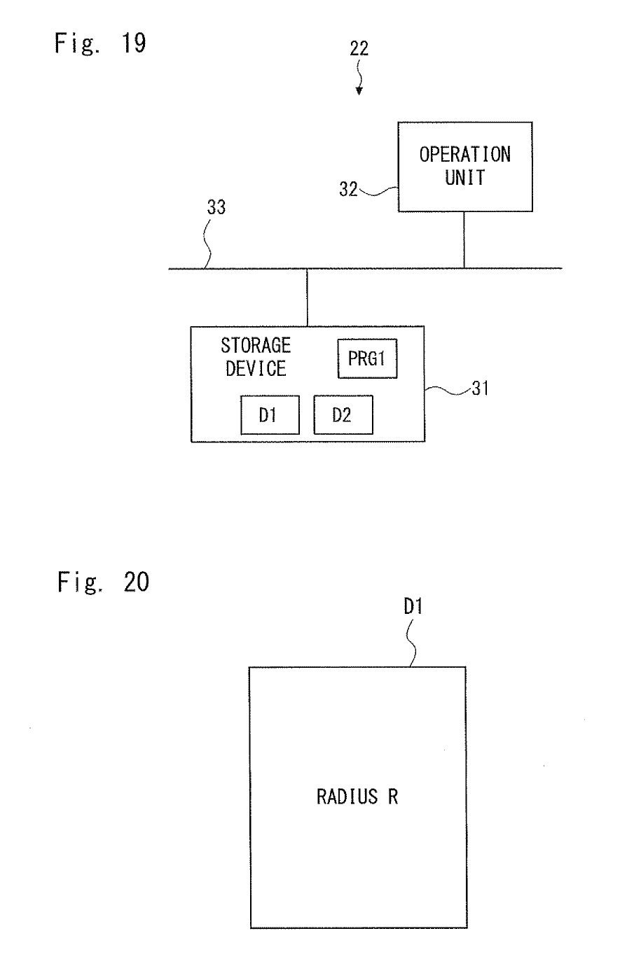

A geographic information management device according to a third exemplary embodiment will be described. This exemplary embodiment illustrates a specific example of the detection of an intersection point as described above with reference to step S13 shown in FIG. 8. FIG. 19 is a block diagram schematically showing the configuration of the intersection point detection unit 22 according to the third exemplary embodiment. The intersection point detection unit 22 includes a storage device 31, an operation unit 32, and a bus 33. The intersection point detection unit 22 is configured using hardware resources such as a computer system.

The storage device 31 can store a database storing data and programs to be supplied for processing in the operation unit 32. For example, various types of storage devices, such as a hard disk drive and a flash memory, can be applied to the storage device 31. Specifically, the storage device 31 stores a basic form database D1 and an airspace information database D2.

The basic form database D1 is unique information provided in advance. FIG. 20 is a diagram showing information included in the basic form database D1. The basic form database D1 includes, for example, a radius R of the true sphere CB (the Earth).

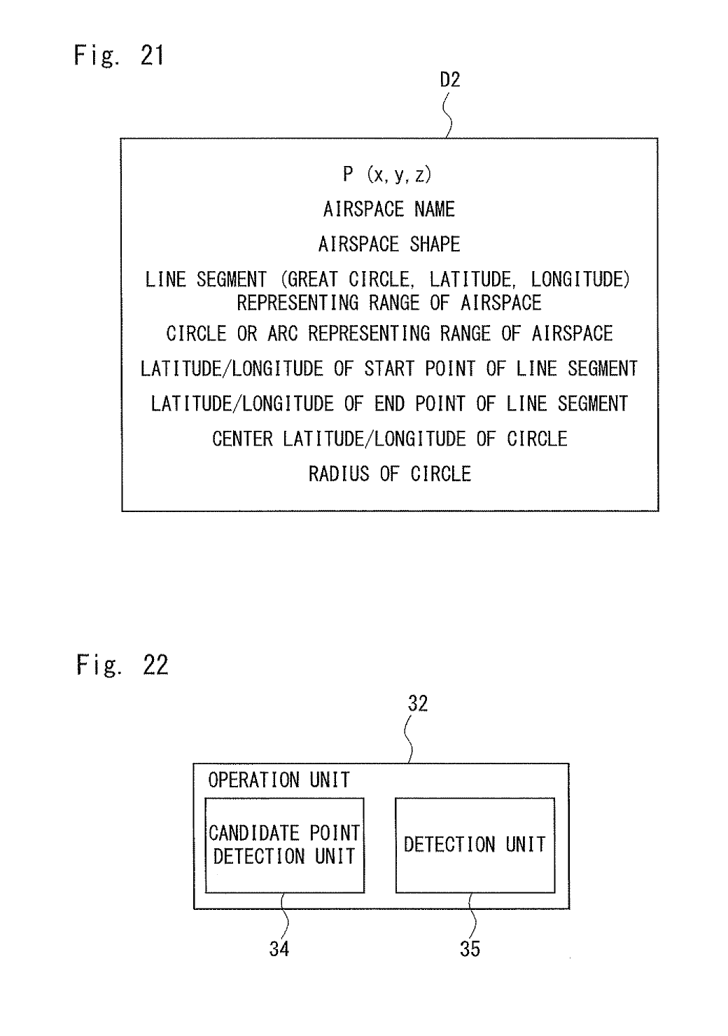

The airspace information database D2 includes coordinate information indicating a line segment or an airspace on the true sphere CB. FIG. 21 is a diagram showing information included in the airspace information database D2. The airspace information database D2 includes information indicating coordinates P (X, Y, Z) of an aircraft on the true sphere CB, a line segment (air route) connecting two points, an airspace name, an airspace shape (such as a circular shape or a rectangular shape), and a range. The airspace information database D2 includes, for example, P (X, Y, Z), a latitude/longitude of a start point of a line segment, a latitude/longitude of an end point of a line segment, airspace shape, a line segment (great circle, latitude, longitude) representing a range of an airspace, information about a circle or an arc representing a range of an airspace, and a center latitude/longitude and a radius for representing a circle.

The storage device 31 can also store a program PRG1 for specifying arithmetic processing for detecting an intersection point between line segments to be described later.

The operation unit 32 is capable of reading the program and database from the storage device 31, and performing necessary arithmetic processing. The operation unit 32 is composed of, for example, a CPU (Central Processing Unit).

FIG. 22 is a block diagram schematically showing a basic configuration of the operation unit 32. The operation unit 32 includes a candidate point detection unit 34 and a detection unit 35. The candidate point detection unit 34 and the detection unit 35 will be described in detail later.

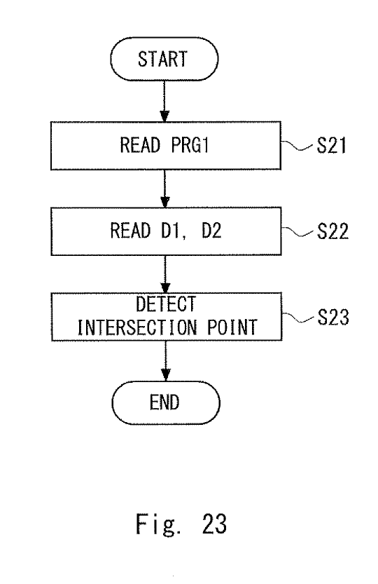

Next, the intersection point detecting operation of the intersection point detection unit 22 will be described. FIG. 23 is a flowchart showing the intersection point detecting operation of the intersection point detection unit 22.

### Step S21

First, the operation unit 32 reads the program PRG1. The program PRG1 is a program for determining whether or not two line segments on the true sphere CB have an intersection point by using the basic form database D1 and the airspace information database D2. Thus, the operation unit 32 functions as a shape determination device including the candidate point detection unit 34 and a detection unit. The program PRG1 is read out from, for example, the storage device 31.

This exemplary embodiment has been described above assuming that the operation unit 32 is composed of a computer and reads the program PRG1. However, the operation unit 32 can be configured as a device in which the candidate point detection unit 34 and the detection unit each having a physical entity are formed.

### Step S22

Next, the operation unit 32 reads out the basic form database D1 and the airspace information database D2 from the storage device 31.

### Step S23

The operation unit 32 substitutes the information included in the basic form database D1 and the airspace information database D2 into the formula specified by the program PRG1, thereby performing the intersection point detecting operation.

The intersection point detecting operation in step S23 will be described in detail below. In the case of indicating a point on the true sphere CB (on the ground surface), a superscript arrow is added to denote a vector quantity in the following formulas and the drawings. For ease of explanation, all vector quantities are normalized. Specifically, a position vector representing a point on the true sphere CB is a position vector normalized by dividing the vector quantities by the radius R of the true sphere CB included in the basic form database D1. For ease of explanation, the normalized vector is hereinafter referred to simply as a vector.

On the true sphere CB, an airspace can be defined as a region surrounded by one or more line segments that do not intersect with each other. In general, a line segment on the true sphere CB is an arc. An arc can be represented as an interval between a start point and an end point on a circle as a closed curve. As premises for understanding the intersection point detecting operation according to this exemplary embodiment, a method for representing a line segment on the true sphere CB will be described below.

A line segment connecting two points as a shortest route on the true sphere, a circle on the true sphere, and an arc connecting two points on the true sphere have already been described in the first exemplary embodiment, and thus the descriptions thereof are herein omitted.

### A Latitude Line Connecting Two Points at the Same Latitude

A latitude line connecting the points P₁ and P₂ at the same latitude on the true sphere CB (on the ground surface) will be described. A latitude line on the true sphere CB (on the ground surface) can be understood as being a rhumb line between two points at the same latitude on the true sphere CB.

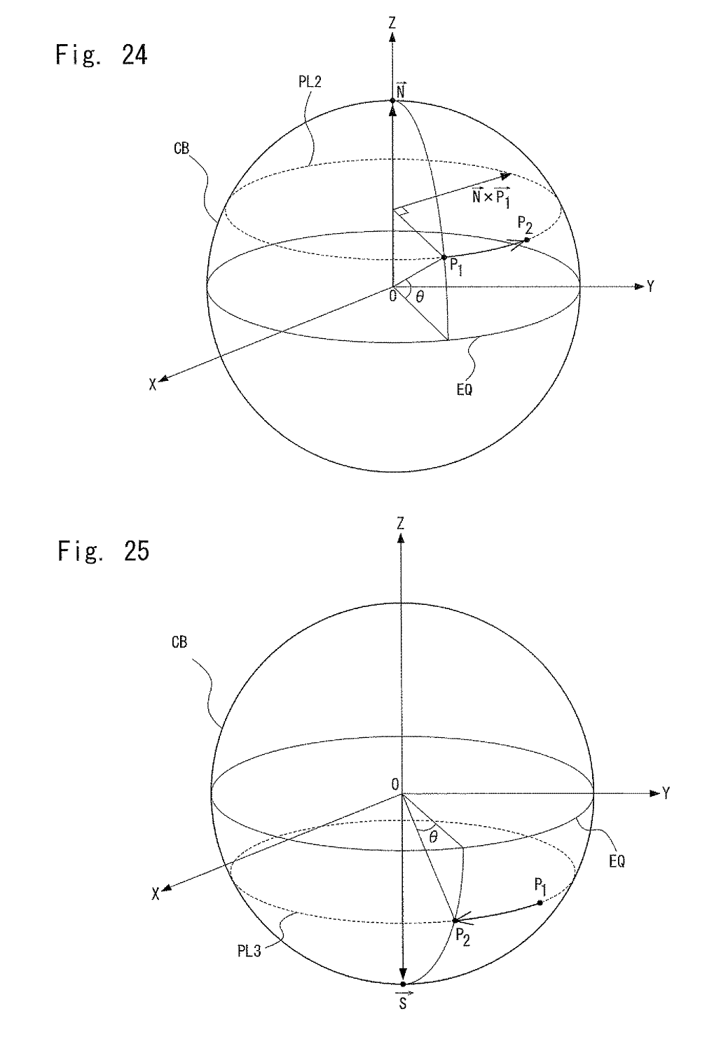

A case where the azimuth from the point P₁ (start point) to the point P₂ (end point) is eastward will be described. FIG. 24 is a diagram showing the case where the azimuth from the point P₁ to the point P₂ on the true sphere CB is eastward. Assuming that a point on the latitude line where the point P₁ and the point P₂ are present on the true sphere CB is represented by P, the position vector for the point P satisfies each vector equation shown in Formula (10). Note that V_{b} represents a unit normal vector for a plane PL2 to which the latitude line where the point P₁ and the point P₂ are present belongs. A pole N represents the north pole of the true sphere CB. The plane PL2 is parallel to the latitude line, so that the unit normal vector V_{b} matches the position vector for the pole N.

[Formula 10]

\vec{V_{b}}=\vec{N}=(0,0,1)

(\vec{V_{b}}·\vec{P})=s_{b} (10)

where s_{b} represents the sine of the angle formed by an equational plane and a latitude θ at which the point P₁ and the point P₂ are present, and is expressed by the following formula (11).

[Formula 11]

s_{b}=sin θ (11)

A case where the azimuth from the point P₁ (start point) to the point P₂ (end point) is westward will be described. FIG. 25 is a diagram showing the case where the azimuth from the point P₁ to the point P₂ on the true sphere CB is westward. Assuming that a point on the latitude line where the point P₁ and the point P₂ are present on the true sphere CB is represented by P, the position vector for the point P satisfies each vector equation shown in Formula (12). Note that V_{c} represents a unit normal vector for a plane PL3 to which the latitude line where the point P₁ and the point P₂ are present belongs. In this case, a pole S on the true sphere CB (a south pole on the ground) is defined. The position vector representing the pole S is expressed by the following formula (12). Since the plane PL3 is parallel to the latitude line, the unit normal vector V_{c} matches the position vector representing the pole S.

[Formula 12]

\vec{V_{c}}=\vec{S}=(0,0,−1)

(\vec{V_{c}}·\vec{P})=s_{c} (12)

where s_{c} represents the sine of the angle formed by the equational plane and the latitude θ at which the point P₁ and the point P₂ are present, has an inverted sign, and is expressed by the following formula (13).

[Formula 13]

s_{c}=−sin θ (13)

Next, how to manage line segments in the intersection point detecting operation will be described. A circle including an arc which is a line segment on the true sphere CB is hereinafter referred to as a reference circle, and an expression that the arc belongs to the reference circle is used.

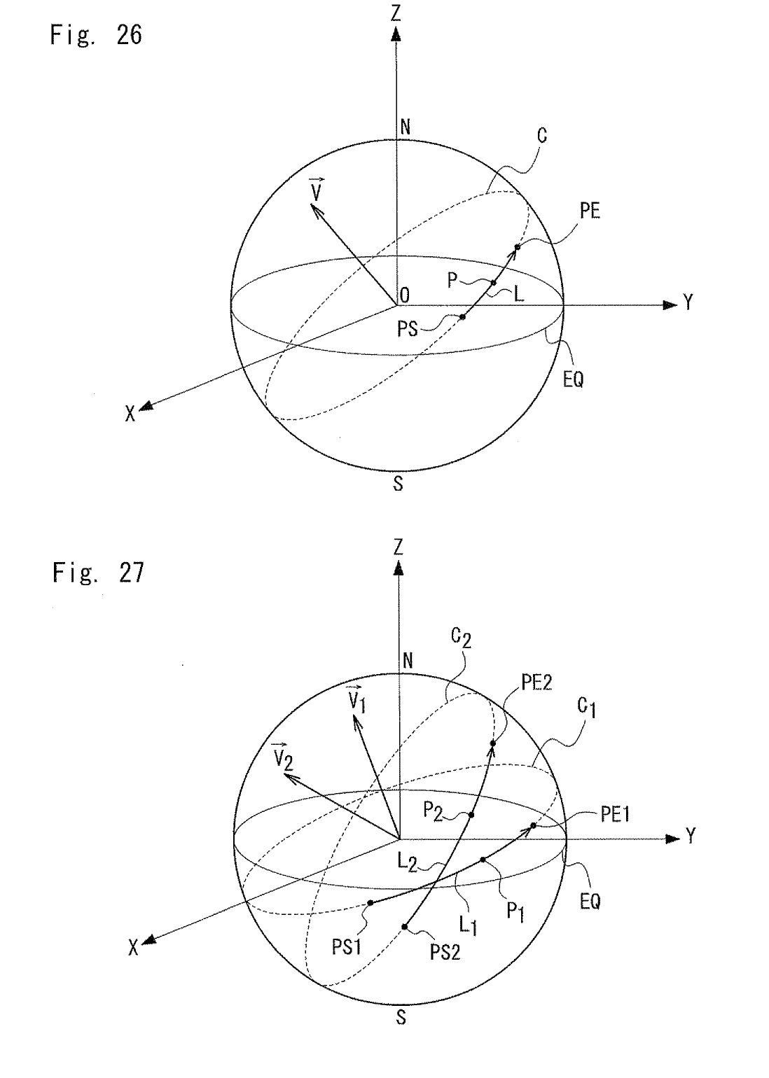

FIG. 26 is a diagram showing the line segment L on the true sphere CB. In this example, the reference circle to which the line segment L which is an arc on the true sphere CB belongs is represented by C, and a point on the circumference of the reference circle C is represented by P. When the reference circle is viewed from above the rue sphere CB, a route that passes from a start point PS to an end point PE counterclockwise on the circumference of the reference circle is defined as the line segment L which belongs to the reference circle C. In FIG. 26 and subsequent figures, the north pole is represented by N; the south pole is represented by S; and the equator is represented by EQ.

The position vector for the point P on the reference circle C satisfies the following formula (14). In Formula (14), s represents a parameter indicating the radius (curvature radius) of the reference circle C, and V represents a unit normal vector for the plane to which the reference circle C belongs.

[Formula 14]

\vec{V}·\vec{P}=s (14)

On the basis of the above premises, an example in which two line segments L₁ and L₂ are present on the true sphere CB will be discussed. FIG. 27 is a diagram showing the two line segments L₁ and L₂ on the true sphere CB. To manage the two line segments L₁ and L₂, the reference circle to which the line segment L₁ belongs is represented by C₁ and the reference circle to which the line segment L₂ belongs is represented by C₂. A parameter indicating the radius (curvature radius) of the reference circle C₁ is represented by s₁, and a parameter indicating the radius (curvature radius) of the reference circle C₂ is represented by s₂. A unit normal vector for the plane to which the reference circle C₁ belongs is represented by V₁. A unit normal vector for the plane to which the reference circle C2 belongs is represented by V₂. A point on the circumference of the reference circle C₁ is represented by P₁, and a point on the circumference of the reference circle C₂ is represented by P₂. In this case, the following formula (15) is obtained by Formula (14).

[Formula 15]

(\vec{V₁}·\vec{P₁})=s₁

(\vec{V₂}·\vec{P₂})=s₂ (15)

The candidate point detection unit 34 of the operation unit 32 detects an intersection point (candidate point) between the reference circle C₁ and the reference circle C₂. In the detection process, an intersection point is detected using a discriminant D as described below. The derivation of the discriminant D will be described below.

An intersection point between the reference circle C₁ and the reference circle C₂ is represented by P_{c}. A position vector for the intersection point P_{c} can be defined by the following formula (16). In Formula (16), β, γ, and δ are arbitrary real numbers.

[Formula 16]

\vec{P_{c}}=β\vec{V₁}+γ\vec{V₂}+δ\vec{V₁}×\vec{V₂} (16)

The intersection point P_{c} needs to satisfy each equation in Formula (15). Accordingly, Formula (16) is substituted into each equation of Formula (15), thereby obtaining the following formula (17).

[Formula 17]

(\vec{V₁}·\vec{P_{c}})=β+γ(\vec{V₁}·\vec{V₂})=s₁

(\vec{V₂}·\vec{P_{c}})=β(\vec{V₁}·\vec{V₂})+γ=s₂ (17)

When Formula (17) is solved for β and γ, the following formula (18) is obtained.

$$\begin{matrix}[ Formula 18 ] & \\ β = \frac{{s}_{1} - {s}_{2} ( \vec{{V}_{1}} - \vec{{V}_{2}} )}{1 - {( \vec{{V}_{1}} - \vec{{V}_{2}} )}^{2}} \\ γ = \frac{{s}_{2} - {s}_{1} ( \vec{{V}_{1}} - \vec{{V}_{2}} )}{1 - {( \vec{{V}_{1}} - \vec{{V}_{2}} )}^{2}} & ( 18 )\end{matrix}$$

At the intersection point P_{c}, the following formula (19) is established.

[Formula 17]

(\vec{P_{c}}·\vec{P_{c}})=1 (19)

When Formula (19) is expanded using Formula (16), the following formula (20) is obtained.

[Formula 20]

β²+γ²+2βγ(\vec{V₁}·\vec{V₂})+δ² (\vec{V₁}·\vec{V₂})²=1 (20)

Formula (18) is substituted into Formula (20) and the formula is solved for δ, thereby obtaining the following formula (21).

$$\begin{matrix}[ Formula 21 ] & \\ δ = \frac{\pm \sqrt{D}}{1 - {( \vec{{V}_{1}} - \vec{{V}_{2}} )}^{2}} & ( 21 )\end{matrix}$$

D shown in Formula (21) represents a discriminant representing whether there is an intersection point, and is expressed by the following formula (22).

[Formula 22]

D=1−(\vec{V₁}·\vec{V₂})²−s₁²−s₂²+2s₁s₂(\vec{V₁}·\vec{V₂}) (22)

Formula (19) includes the square root of the discriminant D. Therefore, to obtain the solution of Formula (14) representing the intersection point P_{c}, it is necessary to sort the cases according to the value of the discriminant D.

### When the Discriminant D Takes a Positive Value (D>0)

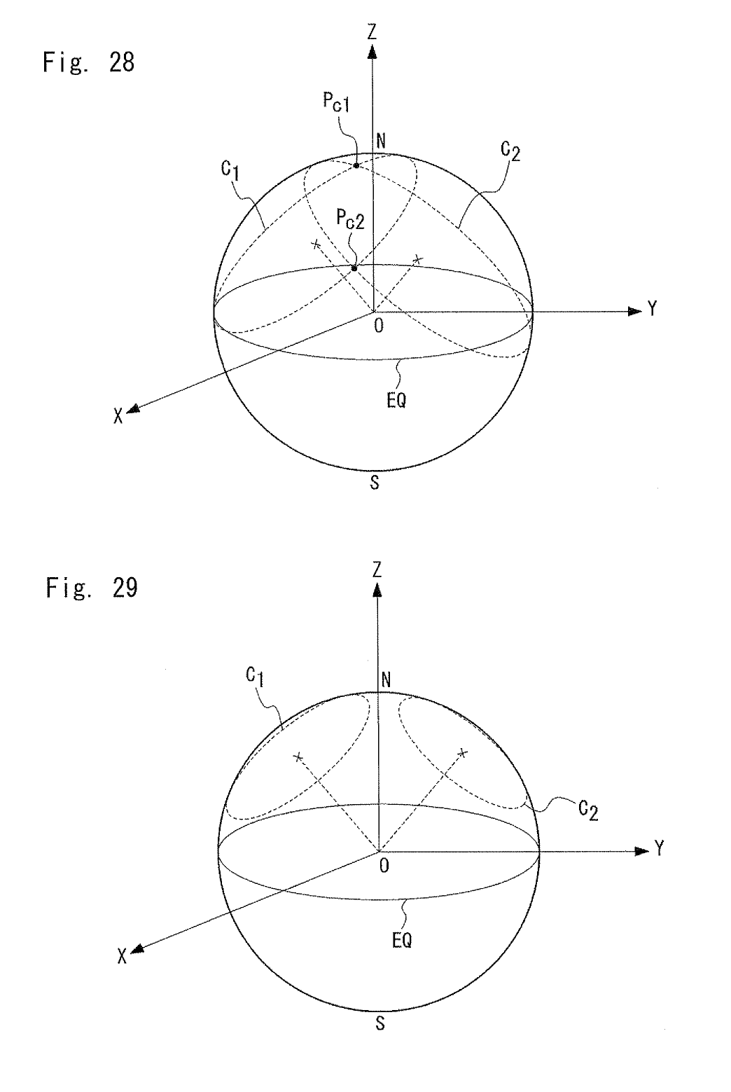

When the discriminant D takes a positive value, δ takes two positive and negative values having the same absolute value. Accordingly, two solutions are obtained for Formula (16) representing the intersection point P_{c}. Specifically, in this case, the reference circle C₁ and the reference circle C₂ intersect with each other at two intersection points P_{c1} and P_{c2} on the true sphere CB. FIG. 28 is a diagram showing a case where the reference circle C₁ and the reference circle C₂ have two intersection points (intersecting with each other).

Formula (18) and Formula (21) are substituted into Formula (16), with the result that the position vectors for the intersection points P_{c1} and P_{c2} are represented by the following formula (23).

$$\begin{matrix} [ Formula 23 ] & \\ \vec{{P}_{c 1}} = \frac{\{ {s}_{1} - {s}_{2} ( \vec{{V}_{1}} \cdot \vec{{V}_{2}} ) \} \vec{{V}_{1}} + \{ {s}_{2} - {s}_{1} ( \vec{{V}_{1}} \cdot \vec{{V}_{2}} ) \} \vec{{V}_{2}} + \sqrt{{DV}_{1}} \times \vec{{V}_{2}}}{1 - {( \vec{{V}_{1}} \cdot \vec{{V}_{2}} )}^{2}} \\ \vec{{P}_{c 2}} = \frac{\{ {s}_{1} - {s}_{2} ( \vec{{V}_{1}} \cdot \vec{{V}_{2}} ) \} \vec{{V}_{1}} + \{ {s}_{2} - {s}_{1} ( \vec{{V}_{1}} \cdot \vec{{V}_{2}} ) \} \vec{{V}_{2}} - \sqrt{{DV}_{1}} \times \vec{{V}_{2}}}{1 - {( \vec{{V}_{1}} \cdot \vec{{V}_{2}} )}^{2}} & ( 23 )\end{matrix}$$

### When the Discriminant D Takes a Negative Value (D<0)

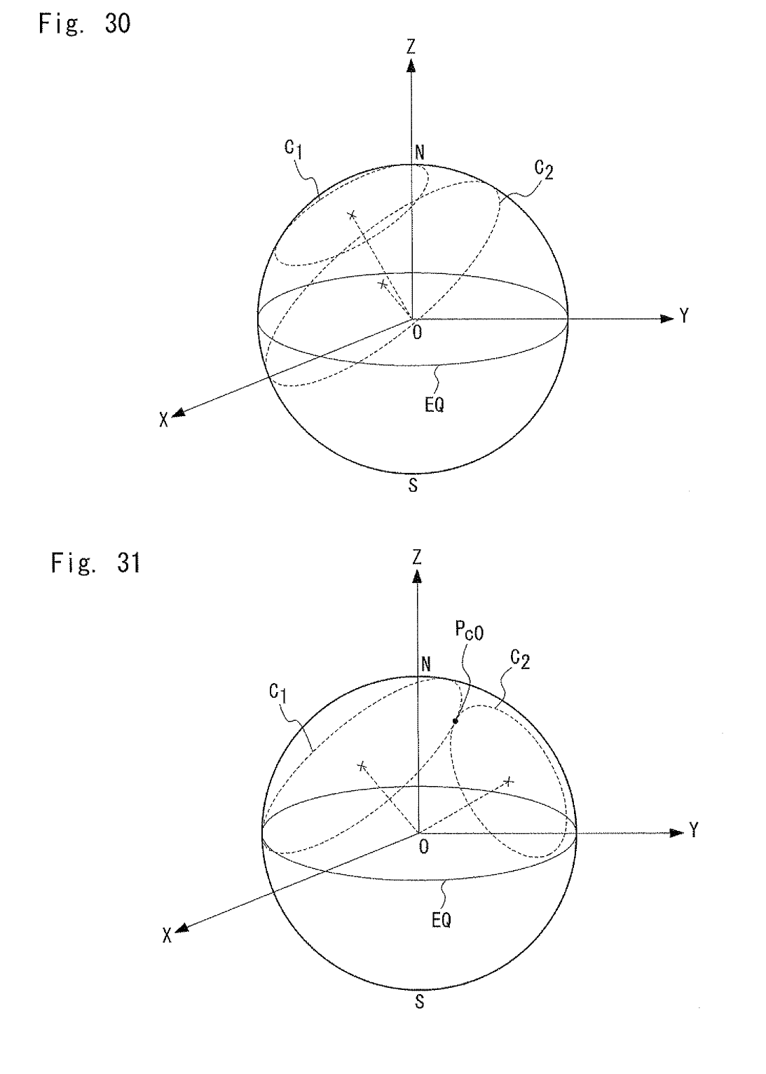

When the discriminant D takes a negative value, δ represents an imaginary number solution. Accordingly, the reference circle C₁ and the reference circle C₂ have no intersection point. When the reference circle C₁ and the reference circle C₂ have no intersection point, the reference circle C₁ and the reference circle C₂ have a separation or inclusion relationship. FIG. 29 is a diagram showing a case where the reference circle C₁ and the reference circle C₂ have a separation relationship. In this case, as shown in FIG. 29, the reference circle C₁ and the reference circle C₂ are spatially isolated, and have no intersection point. FIG. 30 is a diagram showing a case where the reference circle C₁ and the reference circle C₂ have an inclusion relationship. In this case, as shown in FIG. 30, the reference circle C₁ and the reference circle C₂ share a region on the true sphere CB, but the line segment forming the reference circle C₁ and the line segment forming the reference circle C₂ have no intersection point.

### When the Discriminant D is 0 (D=0)

When the discriminant D is 0, δ is also 0. In this case, the reference circle C₁ and the reference circle C₂ are in contact with each other. It can be considered that the reference circle C₁ and the reference circle C₂ are in contact with each other in the following two cases. One is a case where the reference circle C₁ and the reference circle C₂ are circumscribed or inscribed at the intersection point P_{c} as a contact point. The other one is a case where the reference circle C₁ and the reference circle C₂ match.

A Case Where the Reference Circle C₁ and the Reference Circle C₂ are Circumscribed or Inscribed

When the discriminant D is 0 and the following formula (24) is satisfied, the reference circle C₁ and the reference circle C₂ have one intersection point.

[Formula 24]

(\vec{V₁}·\vec{V₂})^{2<}1 (24)

In this case, the position vector for an intersection point P_{c0} between the reference circle C₁ and the reference circle C₂ is represented by the following formula (25) by substituting Formula (18) and Formula (21) into Formula (16).

$$\begin{matrix}[ Formula 25 ] & \\ \vec{{P}_{c 0}} = \frac{\{ {s}_{1} - {s}_{2} ( \vec{{V}_{1}} \cdot \vec{{V}_{2}} ) \} \vec{{V}_{1}} + \{ {s}_{2} - {s}_{1} ( \vec{{V}_{1}} \cdot \vec{{V}_{2}} ) \} \vec{{V}_{2}}}{1 - {( \vec{{V}_{1}} \cdot \vec{{V}_{2}} )}^{2}} & ( 25 )\end{matrix}$$

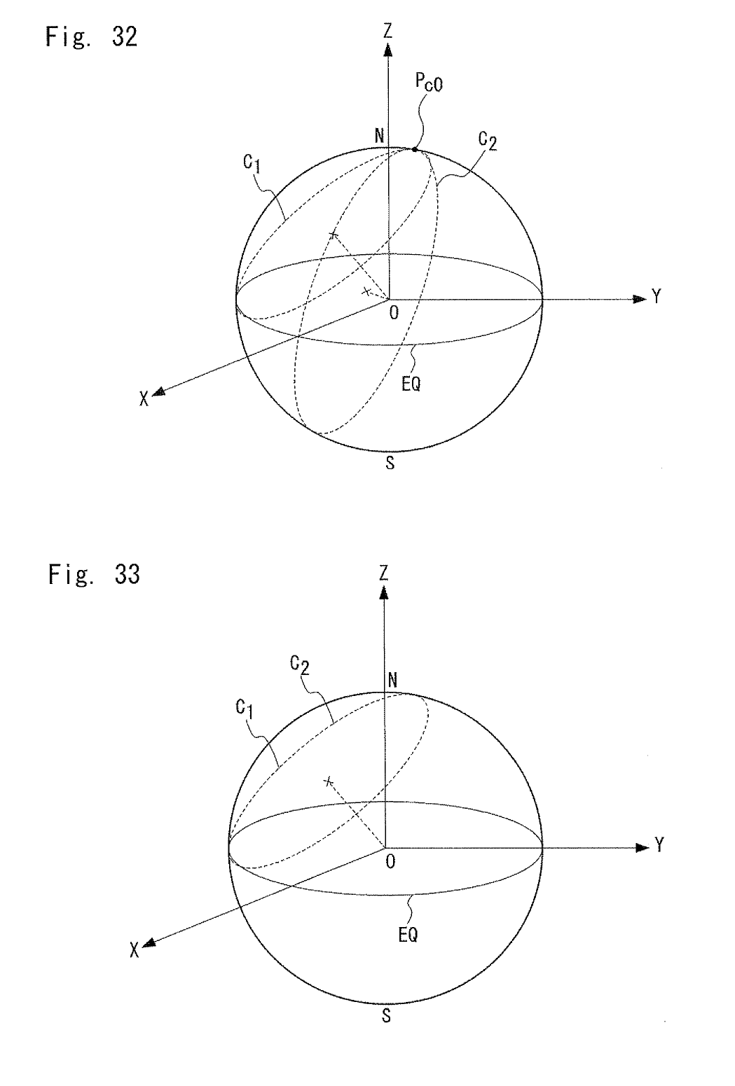

FIG. 31 is a diagram showing a case where the reference circle C₁ and the reference circle C₂ have a circumscribing relationship. In this example, the reference circle C₁ and the reference circle C₂ are circumscribed at the intersection point P_{c0}. FIG. 32 is a diagram showing a case where the reference circle C₁ and the reference circle C₂ have an inscribing relationship. In this example, the reference circle C₁ is inscribed in the reference circle C₂ at the intersection point P_{c0}.

When the Reference Circle C₁ and the Reference Circle C₂ Match

When the discriminant D is 0 and the following formula (26) is satisfied, the reference circle C₁ and the reference circle C₂ match.

[Formula 26]

(\vec{V₁}·\vec{V₂})^{2 =}1 (26)

FIG. 33 is a diagram showing the case where the reference circle C₁ and the reference circle C₂ match. In this example, the reference circle C₂ is a circle identical with the reference circle C₁. In this case, intersection point are present at arbitrary locations on the perimeter of the reference circle C₁ and the reference circle C₂. In this case, a start point and an end point of each of two line segments are set as intersection points.

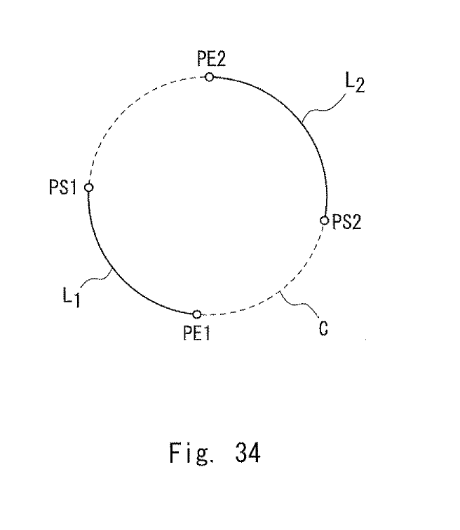

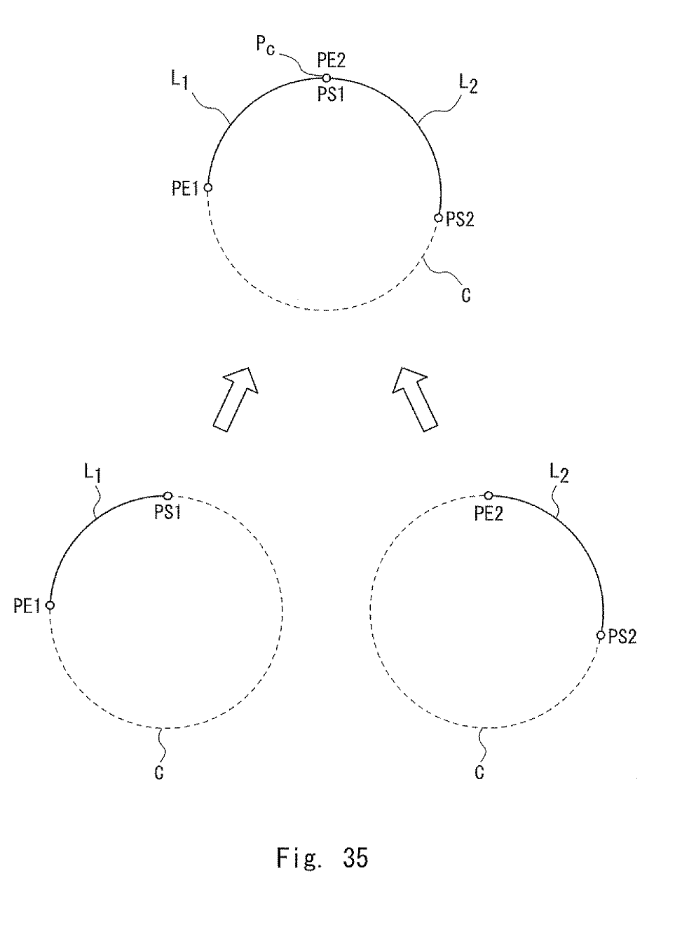

FIG. 34 is a diagram showing a case where the reference circles match and the two line segments are separated from each other. In this example, four points including a start point PS1 of the line segment L₁, an end point PE1 of the line segment L₁, a start point PS2 of the line segment L₂, and an end point PE2 of the line segment L₂ are set as the intersection point P_{c}.

FIG. 35 is a diagram showing a case where the reference circles match and the start point of one of the line segments overlaps the end point of the other one of the line segments. In this example, three points including the point, which is identical with the start point PS1 of the line segment L₁ and the end point PE2 of the line segment L₂, the end point PE1 of the line segment L₁, and the start point PS2 of the line segment L₂ are set as the intersection point P_{c}.

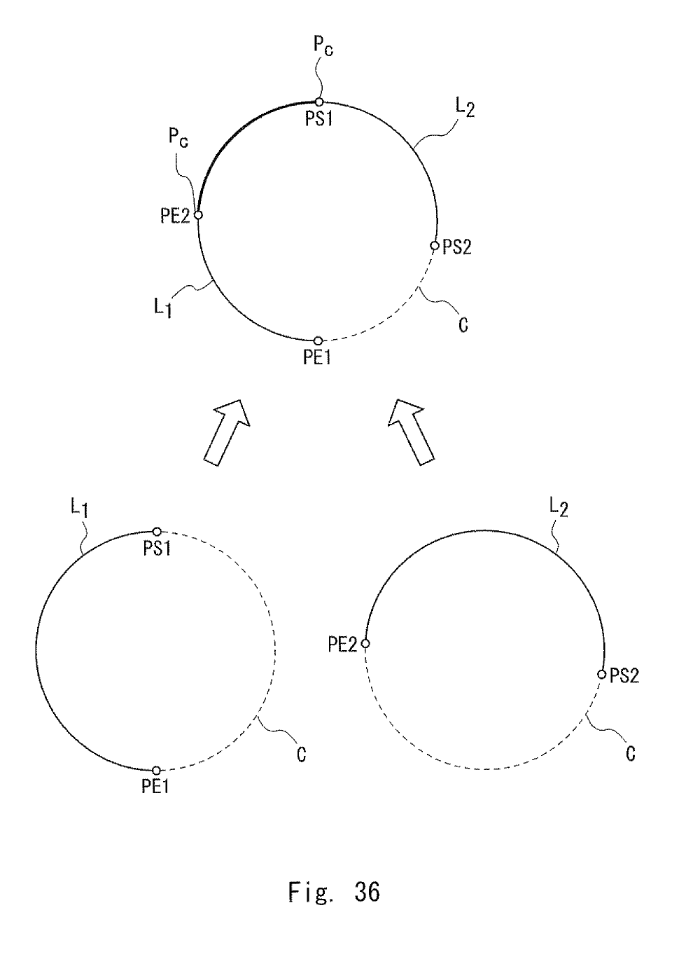

FIG. 36 is a diagram showing a case where the reference circles match and there is one overlapping portion between the two line segments. In this example, four points including the start point PS1 of the line segment L₁, the end point PE1 of the line segment L₁, the starting point PS2 of the line segment L₂, and the end point PE2 of the line segment L₂ are set as the intersection point P_{c}.

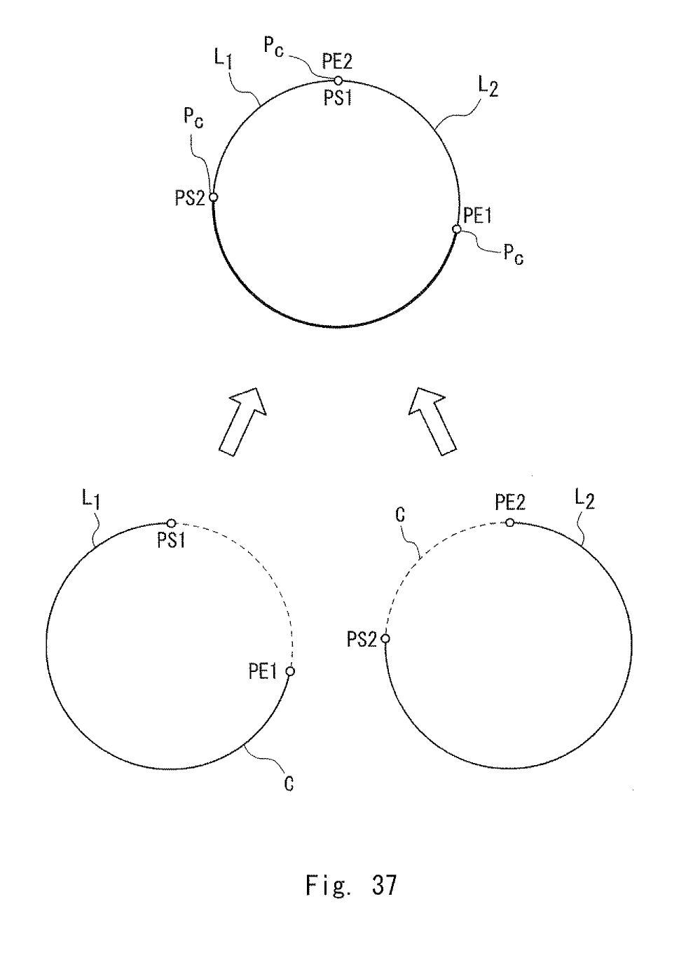

FIG. 37 is a diagram showing a case where the reference circles match; the start point of one of the line segments overlaps the end point of the other one of the line segments; and there is one overlapping portion between the two line segments. In this example, three points including the point, which is identical with the start point PS1 of the line segment L₁ and the end point PE2 of the line segment L₂, the end point PE1 of the line segment L₁, and the start point PS2 of the line segment L₂ are set as the intersection point P_{c}.

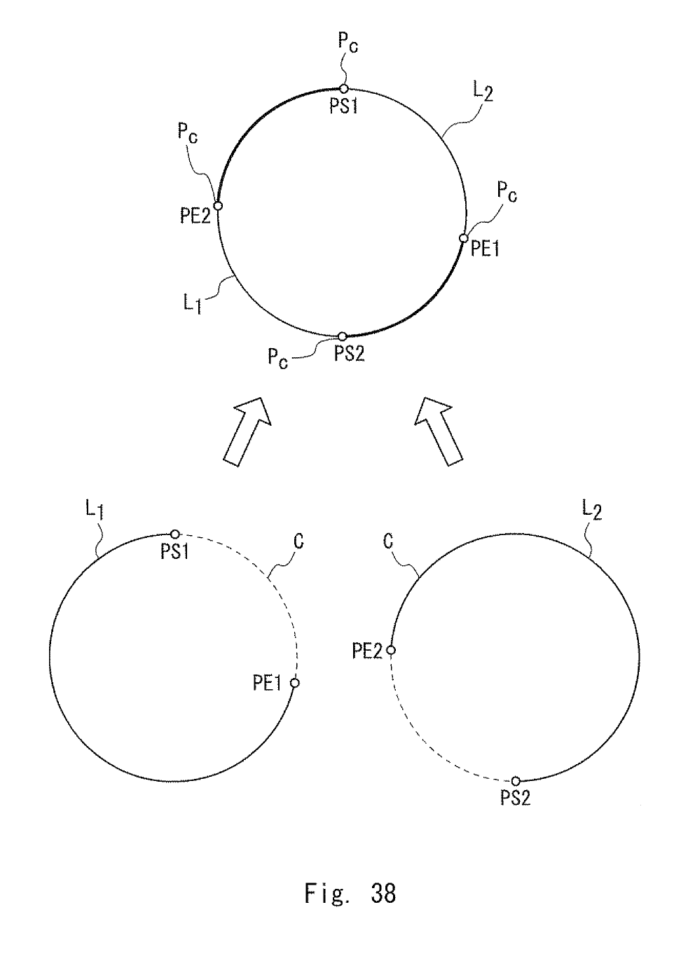

FIG. 38 is a diagram showing a case where the reference circles match and there are two overlapping portions between the two line segments. In this example, four points including the start point PS1 of the line segment L₁, the end point PE1 of the line segment L₁, the start point PS2 of the line segment L₂, and the end point PE2 of the line segment L₂ are set as the intersection point P_{c}.

The determination as to whether or not two reference circles have an intersection point and the determination as to whether or not two reference circles match have been described above. However, it is necessary to consider the interval between line segments on the reference circle in the determination as to whether two line segments have an intersection point. Specifically, when the intersection point between the reference circle C₁ and the reference circle C₂ is not present in the interval between the line segment L₁ and the line segment L₂, the line segment L₁ and the line segment L₂ have no intersection point.

Accordingly, in this exemplary embodiment, the intersection point between the reference circle C₁ and the reference circle C₂ does not necessarily correspond to the intersection point between the line segment L₁ and the line segment L₂. Therefore, in order to distinguish the intersection point between the reference circle C₁ and the reference circle C₂ from the intersection point between the line segment L₁ and the line segment L₂, the detected intersection point between the reference circle C₁ and the reference circle C₂ is referred to as a candidate point.

A method in which the detection unit 35 determines whether or not the line segment L₁ on the reference circle C₁ includes the candidate point P_{c} represented by Formula (14) will be described below. In the determination, the cases are sorted according to the center angle Ψ of the line segment L₁.

### When the Center Angle Ψ is Equal to or More Than π and Equal to or Less Than 2π (π≦Ψ≦2π)

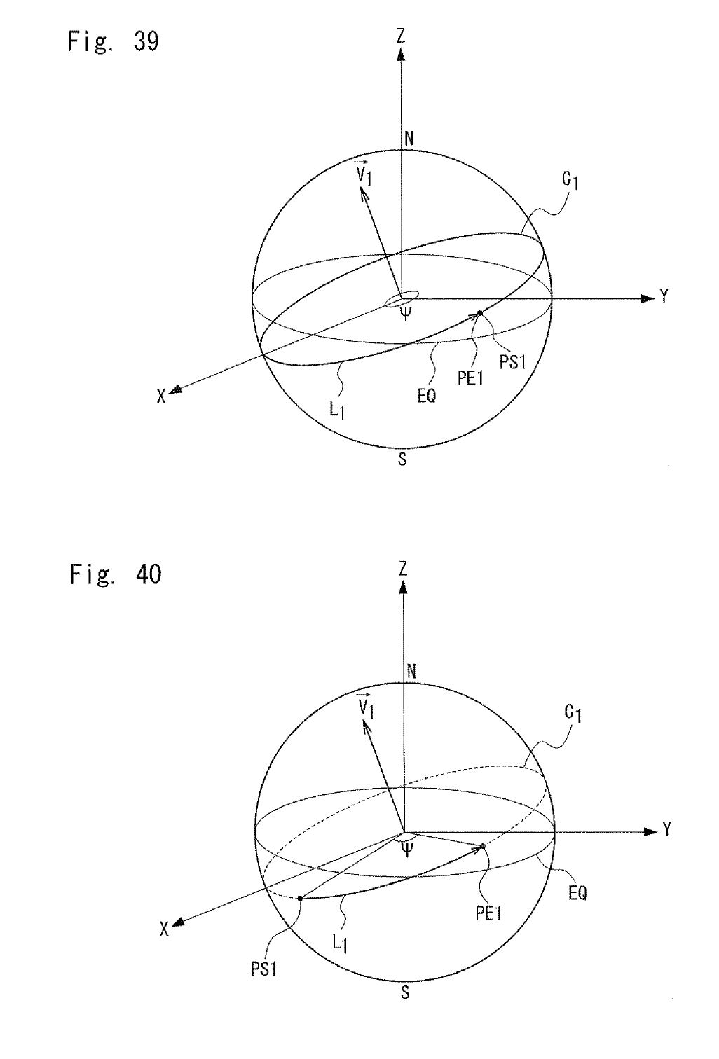

FIG. 39 is a diagram showing the line segment L₁ when the center angle Ψ is 2π (Ψ=2π). When the center angle Ψ is 2π, the candidate point P_{c} is present on the line segment L₁. FIG. 40 is a diagram showing the line segment L₁ when the center angle Ψ is equal to or more than π and smaller than 2π (π≦Ψ<2π). In this case, the line segment L₁ is a half-arc or a superior arc and the following formula (27) is satisfied.

[Formula 27]

(\vec{PS}×\vec{PE})·\vec{V₁}≦0 (27)

When the following formula (28) or (29) is satisfied, the candidate point P_{c} is present on the line segment L₁.

[Formula 28]

\vec{P_{c}}·(\vec{V₁}×\vec{PS})≧0 (28)

[Formula 29]

\vec{P_{c}}·(\vec{V₁}×\vec{PE})≦0 (29)

When the Center Angle Ψ is Smaller than π (0<Ψπ)

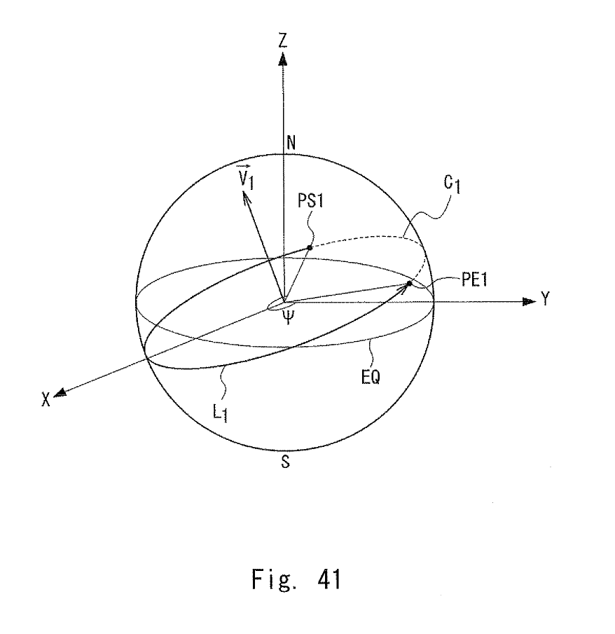

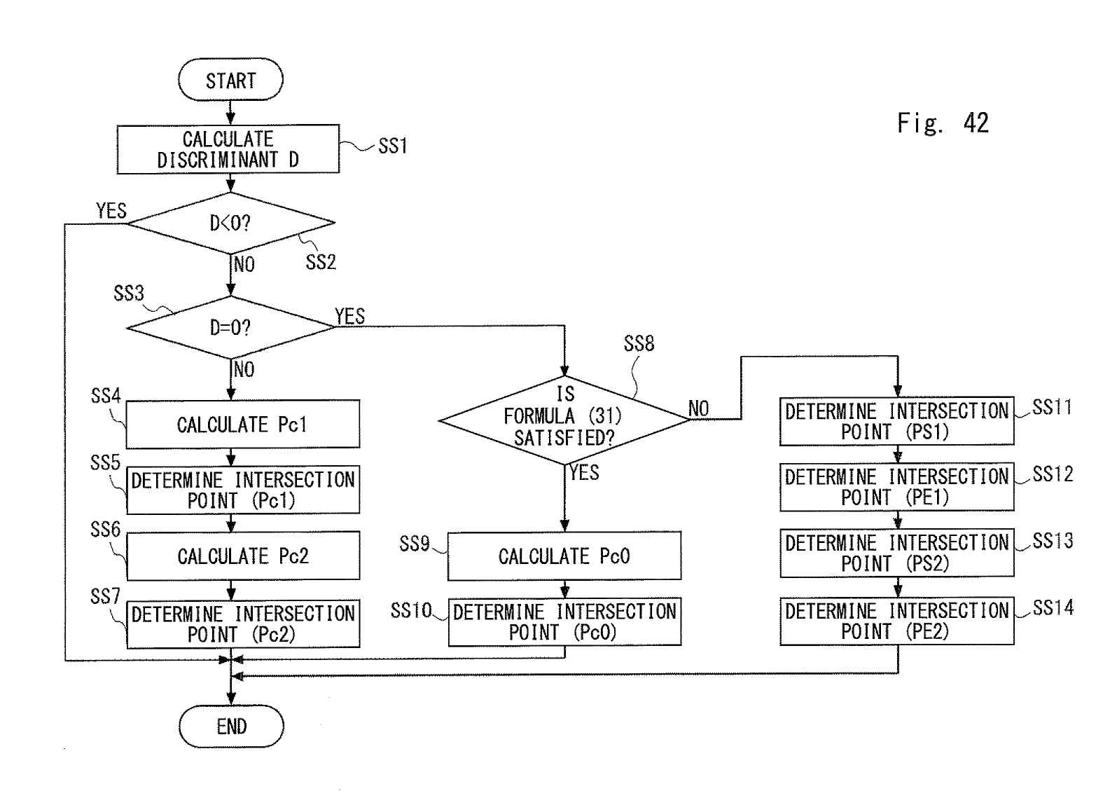

FIG. 41 is a diagram showing the line segment L₁ when the center angle Ψ is smaller than π (0<Ψπ). In this case, the arc is a minor arc, and the following formula (30) is satisfied.

[Formula 30]

(\vec{PS}×\vec{PE})·\vec{V₁}>0 (30)

When both Formulas (28) and (29) are satisfied, the candidate point P_{c} is present on the line segment L₁.

While the method for determining whether the line segment L₁ has an intersection point has been described above, it can be determined whether or not the line segment L₂ has an intersection point.

Thus, when the line segment L₁ and the line segment L₂ include the same candidate point P_{c}, it can be determined that the candidate point is identical with the intersection point P_{c}. In this case, the line segment L₁ and the line segment L₂ intersect with each other at two points (this state is referred to as an intersecting state), and thus it can be determined that the line segments are in contact with each other or match.

The above-described procedure for detecting an intersection point (step S23 shown in FIG. 23) is summarized below. FIG. 42 is a flowchart showing the operation of detecting an intersection point between line segments in the intersection point detection unit 22.

### Step SS1

The candidate point detection unit 34 calculates the discriminant D.

Step SS2 The candidate point detection unit 34 determines whether or not the discriminant D is smaller than 0. Accordingly, it can be determined whether there is a candidate point. When the discriminant D is smaller than 0, there is no candidate point. When the discriminant D is equal to or greater than 0, there is at least one candidate point.

### Step SS3

When the discriminant D is equal to or greater than 0, the detection unit 35 determines whether the discriminant D is 0.

### Step SS4

When the discriminant D is greater than 0, the detection unit 35 calculates the candidate point P_{c1}.

### Step SS5

The detection unit 35 performs intersection point determination processing on the candidate point P_{c1}. The intersection point determination processing will be described later.

### Step SS6

The detection unit 35 calculates the candidate point P_{c2}.

### Step SS7

The detection unit 35 performs the intersection point determination processing on the candidate point P_{c2}. The intersection point determination processing will be described later.

### Step SS8

When the discriminant D is 0, the detection unit 35 determines whether Formula (31) is satisfied.

[Formula 31]

(\vec{V₂}·\vec{V₁})²<1 (31)

### Step SS9

When Formula (31) is satisfied, the detection unit 35 calculates the candidate point P_{c0}.

### Step SS10

The detection unit 35 performs the intersection point determination processing on the candidate point P_{c0}. The intersection point determination processing will be described later.

### Step SS11

When Formula (31) is not satisfied, the detection unit 35 performs the intersection point determination processing on the start point PS1 of the line segment L₁.

### Step SS12

The detection unit 35 performs the intersection point determination processing on the end point PE1 of the line segment L₁.

### Step SS13

The detection unit 35 performs the intersection point determination processing on the start point PS2 of the line segment L₂.

### Step SS14

The detection unit 35 performs the intersection point determination processing on the end point PE2 of the line segment L₂.

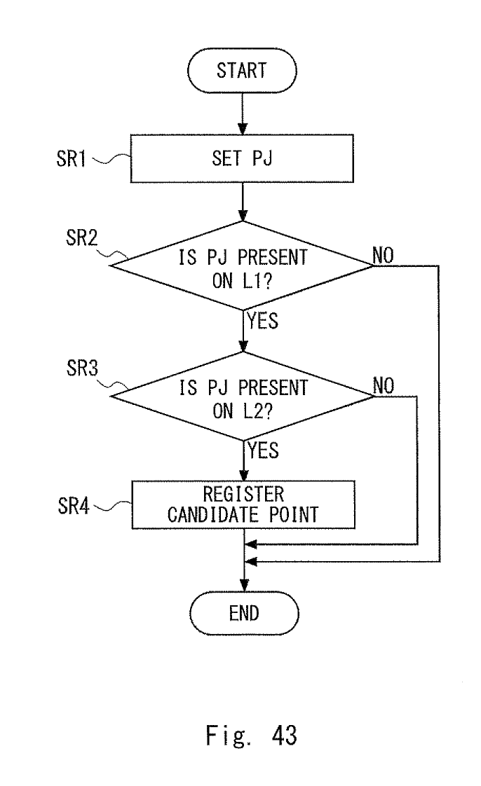

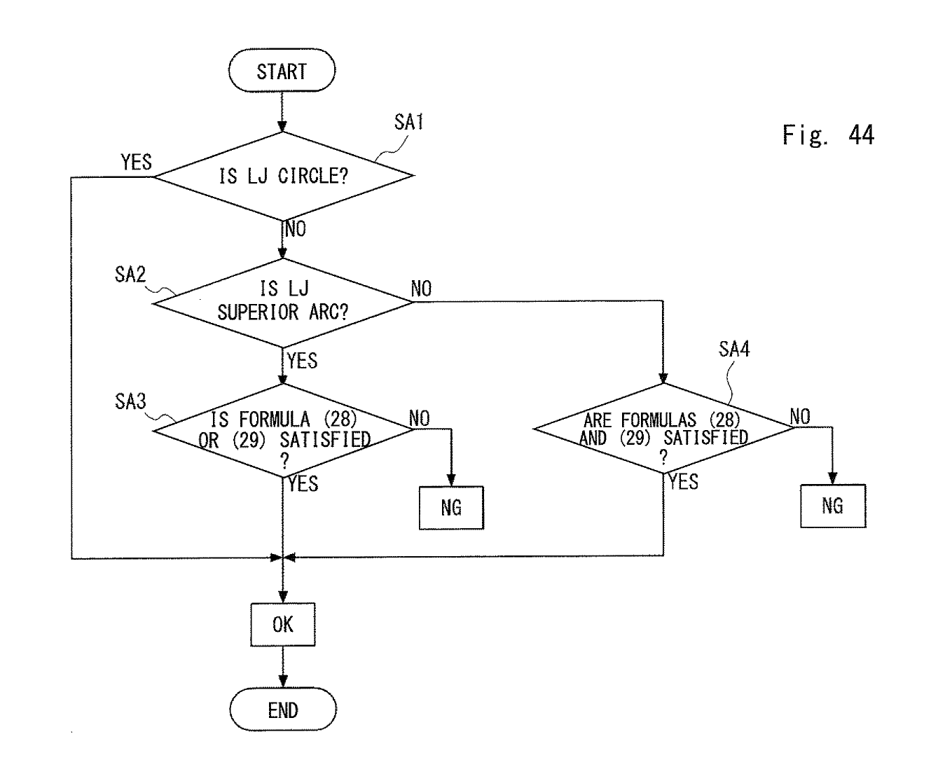

Next, the intersection point determination processing will be described. FIG. 43 is a flowchart showing the intersection point determination processing.

### Step SR1

As the determination target point PJ, the candidate point calculated in the previous step is set.

### Step SR2

A range verification process for determining whether the determination target point PJ is present on the line segment L₁ is carried out. The range verification process will be described in detail later. When the determination target point PJ is not present on the line segment L₁, the processing is terminated.

### Step SR3

When the determination target point PJ is present on the line segment L₁, a range verification process for determining whether the determination target point PJ is present on the line segment L₂ is carried out. The range verification process will be described in detail later. When the determination target point PJ is not present on the line segment L₂, the processing is terminated.

### Step SR4

When the determination target point PJ is present on the line segments L₁ and L₂, the determination target point PJ is registered as a candidate point.

The range verification process in the above-mentioned steps SR2 and SR3 will be described. FIG. 44 is a flowchart showing the range verification process. A line segment to be verified is referred to as a line segment LJ.

### Step SA1

It is determined whether the determination target line segment LJ is a circle.

### Step SA2

When the determination target line segment LJ is not a circle, it is determined whether the line segment is a superior arc.

### Step SA3

When the determination target line segment LJ is a superior arc or a half-arc, it is determined whether at least one of Formula (28) and Formula (29) is satisfied. When at least one of Formula (28) and Formula (29) is satisfied, the determination target point PJ is present on the determination target line segment LJ (determination result shows “YES”). When both Formulas (28) and (29) are not satisfied, the determination target point PJ is not present on the determination target line segment LJ (determination result shows “NO”).

### Step SA4

When the determination target line segment LJ is a minor arc, it is determined whether both Formulas (28) and (29) are satisfied. When both Formulas (28) and (29) are satisfied, the determination target point PJ is present on the determination target line segment LJ (determination result shows “YES”). When at least one of Formula (28) and Formula (29) is not satisfied, the determination target point PJ is not present on the determination target line segment LJ (determination result shows “NO”).

As described above, according to this exemplary embodiment, it is possible to reliably determine whether or not two line segments set on the true sphere have an intersection point. Consequently, it is possible to reliably determine whether or not two air routes each represented by an arc on the true sphere intersect with each other, or whether or not line segments each constituting an airspace intersect with each other.

In the above description, the determination as to whether or not typical two line segments have an intersection point has been described. However, it can be understood that the intersection point detection unit 22 can specifically and easily detect whether or not the determination target closed curve AZ1 and the transferred image AZ2 have an intersection point, by applying the detection of an intersection point between two line segments to line segments forming a closed curve surrounding the determination target closed curve AZ1 and line segments forming a closed curve surrounding the transferred image AZ2.

Note that the present invention is not limited to the above exemplary embodiments and can be modified as appropriate without departing from the scope of the invention.

The airspace information processing device and the airspace information processing method performed in the device have been described above. However, the present invention is not limited to these. According to the present invention, arbitrary processing can be implemented by causing a CPU (Central Processing Unit) to execute a computer program.

The program can be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.). The program may be provided to a computer using any type of transitory computer-readable media. Examples of transitory computer-readable media include electric signals, optical signals, and electromagnetic waves. Transitory computer-readable media can provide the program to a computer via a wired communication line (e.g. electric wires, and optical fibers) or a wireless communication line.

While the present invention has been described above with reference to exemplary embodiments, the present invention is not limited to the above exemplary embodiments. The configuration and details of the present invention can be modified in various ways which can be understood by those skilled in the art within the scope of the invention.

### REFERENCE SIGNS LIST

1 CLOSED CURVE READING UNIT
2 TRANSFER UNIT
3 LINE SEGMENT GENERATION UNIT
4 AIRSPACE RECOGNITION UNIT
5 STORAGE UNIT
21 TRANSFER PROCESSING UNIT
22 INTERSECTION POINT DETECTION UNIT
22 INTERSECTION POINT DETECTION UNIT
31 STORAGE DEVICE
32 OPERATION UNIT
33 BUS
34 CANDIDATE POINT DETECTION UNIT
35 DETECTION UNIT
100 AIRSPACE INFORMATION PROCESSING DEVICE
AZ1 DETERMINATION TARGET CLOSED CURVE
AZ2 TRANSFERRED IMAGE
C, C₁, C₂ REFERENCE CIRCLE
CB TRUE SPHERE
CC1 CIRCLE
CC2, CC3 ARC
D1 BASIC FORM DATABASE
D2 AIRSPACE INFORMATION DATABASE
Ld DETERMINATION LINE SEGMENT
Lj DETERMINATION TARGET LINE SEGMENT
Lp TEMPORAL LINE SEGMENT
O CENTER OF TRUE SPHERE
PA, P₀ POINT

What is claimed is:

1. An airspace information processing device comprising:
a transfer unit configured to generate a transferred image by transferring a whole or part of a closed curve representing an outline of an airspace from its original position to another position on a spherical surface in such a manner that the transferred image has no intersection point with the closed curve, the closed curve being formed of one or more line segments on the spherical surface;
a line segment generation unit configured to generate, from the one or more line segments forming the closed curve, a determination line segment having an intersection point with the transferred image and having no intersection point with other line segments forming the closed curve; and
an airspace recognition unit configured to recognize, as the airspace, a region in which the determination line segment is not present, the region being one of two regions on the spherical surface that are defined by the closed curve.

2. The airspace information processing device according to claim 1, wherein the transfer unit generates the transferred image by transferring the closed curve to a point-symmetrical position about a center of a sphere.

3. The airspace information processing device according to claim 1, wherein the transfer unit generates the transferred image by transferring the closed curve to a position where the closed curve is rotated by a predetermined angle about a rotation axis passing through a center of a sphere.

4. The airspace information processing device according to claim 3, wherein the transfer unit is configured to:
generate a first transferred image by transferring the closed curve to a position where the closed curve is rotated by a predetermined angle about a first rotation axis;
set the first transferred image as the transferred image when the first transferred image has no intersection point with the closed curve;
generate a second transferred image by transferring the closed curve to a position where the closed curve is rotated by a predetermined angle about a second rotation axis perpendicular to the first rotation axis, when the first transferred image has an intersection point with the closed curve;
set the second transferred image as the transferred image when the second transferred image has no intersection point with the closed curve;
generate a third transferred image by transferring the closed curve to a position where the closed curve is rotated by a predetermined angle about a third rotation axis when the second transferred image has an intersection point with the closed curve, the third rotation axis passing through the center of the sphere and being perpendicular to the first rotation axis and the second rotation axis; and
set the third transferred image as the transferred image when the third transferred image has no intersection point with the closed curve.

5. The airspace information processing device according to claim 4, wherein the sphere corresponds to the Earth and the first rotation axis corresponds to the axis of the Earth.

6. The airspace information processing device according to claim 3, wherein the rotation axis is perpendicular to a line passing through the center of the sphere and average coordinates of a plurality of coordinates on the closed curve.

7. The airspace information processing device according to claim 3, wherein the rotation axis is perpendicular to a line passing through the center of the sphere and coordinates represented by an average of latitudes and longitudes of a plurality of points on the closed curve.

8. The airspace information processing device according to claim 3, wherein the rotation axis is perpendicular to a line passing through the center of the sphere and one point on the closed curve.

9. The airspace information processing device according to claim 3, wherein the rotation axis is perpendicular to a line passing through the center of the sphere and a midpoint of a line connecting two points on the closed curve.

10. The airspace information processing device according to claim 1, wherein the line segment generation unit is configured to:
set a first point on any one of a plurality of line segments forming the closed curve;
generate a first line segment connecting the first point to a second point on a line segment forming the transferred image;
detect all intersection points between the first line segment and the plurality of line segments forming the closed curve; and
set, as the determination line segment, an interval between the second point and an intersection point closest to the second point among the detected intersection points on the first line segment.

11. An airspace information processing method comprising:
causing a transfer unit to generate a transferred image by transferring a whole or part of a closed curve representing an outline of an airspace from its original position to another position on a spherical surface in such a manner that the transferred image has no intersection point with the closed curve, the closed curve being formed of one or more line segments on the spherical surface;
causing a line segment generation unit to generate, from the one or more line segments forming the closed curve, a determination line segment having an intersection point with the transferred image and having no intersection point with other line segments forming the closed curve; and
causing an airspace recognition unit to recognize, as the airspace, a region in which the determination line segment is not present, the region being one of two regions on the spherical surface that are defined by the closed curve.

12. A non-transitory computer-readable medium storing an airspace information processing program for causing a computer to execute:
processing for generating a transferred image by transferring a whole or part of a closed curve representing an outline of an airspace from its original position to another position on a spherical surface in such a manner that the transferred image has no intersection point with the closed curve, the closed curve being formed of one or more line segments on the spherical surface;
processing for causing a line segment generation unit to generate, from the one or more line segments forming the closed curve, a determination line segment having an intersection point with the transferred image and having no intersection point with other line segments forming the closed curve; and
processing for causing an airspace recognition unit to recognize, as the airspace, a region in which the determination line segment is not present, the region being one of two regions on the spherical surface that are defined by the closed curve.
